(19) United States
(12) Patent Application Publication
(10) Pub. No.: US 2008/0023138 A1
(43) Pub. Date: Jan. 31, 2008

(54) Process for Transferring onto a Surface of an Optical Article a Coating Stack Imparting Antistatic Properties

(75) Inventor: Haipeng Zheng, Clearwater, FL (US)

Correspondence Address: FULBRIGHT & JAWORSKI L.L.P., 600 CONGRESS AVE., SUITE 2400, AUSTIN, TX, 78701, US

(73) Assignee: ESSILOR INTERNATIONAL COMPAGNIE GENERALE D'OPTIQUE

(21) Appl. No.: 11/461,241

(22) Filed: Jul. 31, 2006

(51) Int. Cl. B32B 27/36; B32B 27/00

(52) U.S. Cl. 156/344; 428/412; 428/411.1

(57) ABSTRACT

The present invention relates to processes for transferring a stack of coatings borne by a removable carrier onto at least one surface of the substrate of an optical article. In some particular aspects, the invention concerns processes for transferring a stack of coatings from a carrier to an optical article, which is capable of imparting antistatic, anti-reflection and/or anti-fog properties. The invention also relates to optical articles producible by such methods.

### BACKGROUND OF THE INVENTION

1. Field of the Invention

The present invention relates to a process for preparing an optical article having antistatic and anti-reflection properties involving transferring a stack of coatings from a carrier to at least one geometrically defined surface of the substrate of said optical article. The process can be implemented in a short period of time without any risk of deformation of the substrate.

The invention also relates to a coated carrier for use in the above process.

2. Description of Related Art

It is a common practice in the art to coat at least one main surface of a lens substrate, such as an ophthalmic lens or lens blank, with several coatings for imparting to the finished lens additional or improved optical or mechanical properties. These coatings are designated in general as functional coatings.

Thus, it is usual practice to coat at least one main surface of a lens substrate, typically made of an organic glass material, with successively, starting from the surface of the lens substrate, an impact-resistant coating (impact resistant primer), an abrasion- and/or scratch-resistant coating (hard coat), an anti-reflection coating and, optionally, an anti-fouling top coat. Other coatings, such as a polarized, photochromic or dyeing coating may also be applied onto one or both surfaces of the lens substrate.

Numerous processes and methods have been proposed for coating a surface of optical articles. U.S. Pat. No. 6,562,466 describes a process for transferring coatings from at least one support or mold part onto at least a geometrically defined surface of a lens blank comprising:
providing a lens blank having at least one geometrically defined surface;
providing a support or mold part having an internal surface bearing a coating and an external surface;
depositing onto said geometrically defined surface of said lens blank or onto said coating a pre-measured amount of a curable adhesive composition;
moving relatively to each other the lens blank and the support to either bring the coating into contact with curable adhesive composition or bring the curable adhesive composition into contact with the geometrically defined surface of the lens blank;
applying a sufficient pressure onto the external surface of the support so that the thickness of a final adhesive layer once the curable composition cured is less than 100 micrometers;
curing the layer of adhesive composition; and
withdrawing the support or mold part to recover the lens blank with the coating adhered onto the geometrically defined surface of said lens blank.

U.S. Pat. No. 6,562,466 uses a liquid light- or thermally-curable adhesive composition during the transfer of the coating layers from the carrier to the surface of the lens substrate. The liquid curable adhesive composition is required to stick both to the exposed coating on the carrier and the geometrically defined surface of the lens substrate.

It is well known that optical articles, which are composed of essentially insulating materials, have a tendency to get charged with static electricity, especially when they are cleaned in dry conditions by rubbing their surface with a cloth or synthetic piece, for example a polyester piece (triboelectricity). The charges which are present at the surface of said optical articles create an electrostatic field capable of attracting and fixing, as long as the charge remains on optical articles, objects lying in the vicinity thereof (a few centimeters) that have a very little weight, generally small size particles such as dusts.

In order to decrease or suppress attraction of the particles, it is necessary to decrease the intensity of the electrostatic field, i.e. to decrease the number of static charges which are present at the surface of the article. This may be carried out by imparting mobility to the charges, for instance by introducing in the optical article a layer of a material inducing a high mobility of the charges. Materials inducing the highest mobility are conductive materials. Thus, a material having a high conductivity allows dissipating more rapidly charges.

It is known in the art that an optical article acquires antistatic (AS) properties owing to the incorporation at the surface thereof, in the stack of functional coatings, of at least one electrically conductive layer, which is called an antistatic layer. The presence of such a layer in the stack imparts to the article AS properties, even if the AS coating is interleaved between two coatings or two substrates which are not antistatic.

By “antistatic”, it is meant the property of not retaining and/or developing an appreciable electrostatic charge. An article is generally considered to have acceptable antistatic properties when it does not attract or fix dust or small particles after one of its surfaces has been rubbed with an appropriate cloth. It is capable of quickly dissipating accumulated electrostatic charges.

This property if often related to the static potential of the material. When the static potential of the material (measured when the article has not been charged) is 0 KV±0.1 KV (in absolute value), the material is antistatic. On the contrary, when its static potential is different from 0 KV±0.1 KV (in absolute value), the material is said static.

The ability of a glass to evacuate a static charge created by rubbing with a cloth or any other electrostatic charge generation process (charge applied by corona . . . ) can be quantified by measuring the time required for said charge to be dissipated (charge decay time). Thus, antistatic glasses have a discharge time in the order of 100 milliseconds, while static glasses have a discharge time in the order of several tenths seconds, sometimes even several minutes. A static glass having just been rubbed can thus attract surrounding dusts as long as it requires time to get discharged.

Known antistatic coatings comprise at least one antistatic agent, which generally is an optionally doped (semi-)conductive metallic oxide, such as indium oxide doped with tin (ITO), tin oxide doped with antimony vanadium pentoxyde or a conductive polymer having a conjugated structure.

The patents EP 0834092 and U.S. Pat. No. 6,852,406 describe antistatic optical articles, in particular ophthalmic lenses, having a mineral anti-reflection (AR) coating comprising a transparent antistatic layer based on conductive oxides such as indium-tin oxide (ITO) or tin oxide, which has been deposited by vacuum evaporation. The coatings described in those patents are not fully satisfactory. In addition, deposition cost of the inorganic antistatic layer is expensive. Moreover, it is preferable to have optical articles in which the antistatic coating is independent from the AR coating.

Another problem is that such optical articles having an electrically conductive layer within the anti-reflection stack cannot be prepared by the above described transfer processes from at least one support or carrier. The present inventors have observed that corona treatment of such an antistatic AR stack borne by a carrier led to crazing problems. The corona surface treatment is an optional and preferred step to obtain adhesion of the subsequent coating, generally an anti-abrasion layer, to the AR stack.

Therefore, new carriers are needed bearing coating stacks capable of imparting antistatic and anti-reflection properties to an optical article upon transfer to its surface.

As described above, the coating transfer processes of U.S. Pat. No. 6,562,466 requires the use of a curable adhesive composition which is deposited onto the exposed surface of the outermost coating of the coating stack or onto the optical article.

Many patents describe antistatic adhesive compositions in which inorganic salts or oxides have been included as antistatic agents, for example U.S. Pat. Nos. 5,004,562 and 5,194,182 which use various inorganic salts, U.S. Pat. No. 5,637,368 which uses vanadium oxide, U.S. Pat. No. 5,885,708 which uses lithium salts, U.S. Pat. No. 4,145,327, U.S. Pat. No. 6,028,132 and U.S. Pat. No. 6,562,428 which use quaternary ammonium salts. Furthermore, US patent application No. 2005/014892 discloses a type of water-based polyurethane antistatic adhesive for dry laminate applications, which contains an electrolytic metallic salt used as the antistatic agent, including one or more salts selected from the group consisting of sodium chloride, magnesium chloride, potassium chloride, sodium nitrate, magnesium nitride, potassium nitrate, and the like.

US patent application No. 2003/096178 discloses an antistatic adhesive material which is a mixture of a polymer compound, such as a synthetic resin, and a knead type antistatic agent. The antistatic agents can be selected from carbon black, glyceric fatty acyl ester, polyoxy alkylene alkyl ethers, polyoxy alkylene alkyl amines, alkyl diethanolamine, alkyl sulfonates, alkyl phosphates and the like.

The above cited documents do not disclose the use of antistatic compositions capable of allowing adhesion comprising an organic polymeric conductive component.

### SUMMARY OF THE INVENTION

Therefore, a first object of the invention is to provide a process for transferring a stack of coatings from a carrier to an optical article, which is capable of imparting antistatic and anti-reflection or anti-fog properties, and avoids the drawbacks of the prior art processes, in particular the crazing problem of AR coatings incorporating an antistatic layer, when subjected to a surface pre-treatment, such as a corona treatment.

Another object of the invention is to provide a process as above, which uses a layer of a composition capable of allowing adhesion formed between the main surface of an optical article and the exposed surface of the coating stack to be transferred, wherein said composition capable of allowing adhesion is based on organic conductive polymers.

Yet another object of the invention is to provide a process which delivers optical articles presenting high transmittance, low haze, and excellent adhesion, antistatic properties and AR performances.

A further object of the invention is to provide a process which could be easily integrated into the classical manufacturing chain, without requiring significant modifications of the transfer processes already in use.

Still a further object of this invention is to provide a carrier for use in the above process, bearing an anti-reflection coating and which is capable of conferring antistatic properties to an optical article. Such a carrier would be particularly interesting if it could be stored in view of a subsequent implementation in a transfer process.

To achieve the foregoing objects, and in accordance with the invention as embodied and broadly described herein, the present invention relates to a process for transferring a stack of coatings borne by a removable carrier onto at least one geometrically defined surface of the substrate of an optical article, comprising:
(a) obtaining a carrier having a main surface bearing a stack of coatings, said stack having an exposed surface and comprising at least the following coatings:
   an anti-reflection coating,
   optionally, at least one functional coating;
(b) obtaining an optical article comprising a substrate having at least one geometrically defined surface;
(c) depositing either onto the exposed surface of the coating stack borne by the carrier or the at least one geometrically defined surface of the substrate a layer of a composition capable of allowing adhesion of said at least one geometrically defined surface of the substrate to the exposed surface of said coating stack;
(d) moving the carrier and the optical article relatively to each other to bring the deposited layer of composition capable of allowing adhesion into contact with either said at least one geometrically defined surface of the substrate or the exposed surface of said coating stack;
(e) pressing together the at least one geometrically defined surface of the substrate and the exposed surface of said coating stack, said layer of composition capable of allowing adhesion lying there between;
(f) optionally, heating or curing the layer of composition capable of allowing adhesion during pressing step (e);
(g) stopping pressing step (e); and
(h) withdrawing the removable carrier to recover an optical article having a substrate coated with said coating stack adhering to said at least one geometrically defined surface through the layer of composition allowing adhesion, wherein:
α) said stack of coatings borne by the removable carrier further comprises, in addition to said anti-reflection coating, an organic antistatic coating comprising at least one conductive polymer; and/or
β) said composition capable of allowing adhesion is an organic antistatic coating composition comprising at least one conductive polymer, and/or at least one conductive polymer precursor, (for example polyvinylphenylene precursor), and at least one binder.

The present invention also encompasses the case in which the composition capable of allowing adhesion is pre-deposited either on the exposed surface of the coating stack borne by the carrier or on a geometrically defined surface of the substrate, which may be stored and later used in the process steps d) to h) of the invention.

The present invention also relates to a carrier having a main surface bearing a stack of coatings, said stack having an exposed surface and comprising an anti-reflection coating and optionally at least one functional coating, wherein:
α) said stack of coatings borne by the carrier further comprises, in addition to said anti-reflection coating, an organic antistatic coating comprising at least one conductive polymer; and/or
β) a layer of an adhesive composition is deposited on the exposed surface of the coating stack borne by the carrier, said adhesive composition being an organic antistatic coating composition comprising at least one conductive polymer, and/or at least one conductive polymer precursor, and at least one binder.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The foregoing and other objects, features and advantages of the present invention will become readily apparent to those skilled in the art from a reading of the detailed description hereafter when considered in conjunction with the accompanying drawings wherein:

FIGS. 1A to 1C are schematic views of the main steps of a first embodiment of the process of the invention for transferring a coating stack onto at least one geometrically defined surface of a substrate, in which the layer of adhesive composition is deposited onto the exposed surface of said coating stack;

FIGS. 2A to 2C are schematic views of the main steps of a second embodiment of the process of the invention wherein the layer of adhesive composition is deposited onto said at least one geometrically defined surface of the substrate.

### DETAILED DESCRIPTION OF THE INVENTION AND PREFERRED EMBODIMENTS

The terms “comprise” (and any grammatical variation thereof, such as “comprises” and “comprising”), “have” (and any grammatical variation thereof, such as “has” and “having”), “contain” (and any grammatical variation thereof, such as “contains” and “containing”), and “include” (and any grammatical variation thereof, such as “includes” and “including”) are open-ended linking verbs. They are used to specify the presence of stated features, integers, steps or components or groups thereof, but do not preclude the presence or addition of one or more other features, integers, steps or components or groups thereof. As a result, a method, or a step in a method, that “comprises,” “has,” “contains,” or “includes” one or more steps or elements possesses those one or more steps or elements, but is not limited to possessing only those one or more steps or elements.

Unless otherwise indicated, all numbers or expressions referring to quantities of ingredients, ranges, reaction conditions, etc. used herein are to be understood as modified in all instances by the term “about.”

When the optical article or carrier comprises one or more surface coatings, the term “to deposit a layer onto the optical article or carrier” means that a layer is deposited onto the exposed surface of the outermost coating of the optical article or carrier.

By outermost (or outer) and innermost coatings of a coating stack borne by a carrier, it is meant the coatings of the coating stack which are respectively the furthest from and the closest to the carrier.

A coating that is “on” a carrier or has been deposited “onto” a carrier is defined as a coating that: (i) is positioned over the carrier, (ii) need not be in contact with the carrier, i.e., one or more intervening coatings may be disposed between the carrier and the coating in question, and (iii) need not cover the carrier completely.

According to the invention, the optical article to be coated with the coating stack borne by the carrier comprises a substrate, in mineral or organic glass having rear and front main faces.

The optical article of the present invention preferably is a transparent optical article, more preferably a lens, and even more preferably an ophthalmic lens, which may be finished or semi-finished.

A finished lens is defined as a lens obtained in its definitive shape, having both of its main faces surfaced or cast to the required geometry. It is generally produced by pouring polymerizable compositions between two molds exhibiting required surface geometries and then polymerizing.

A semi-finished lens is defined as a lens having only one of its main faces (generally the front face of the lens) surfaced or cast to the required geometry. The remaining face, preferably the rear face of the lens, has then to be surface-finished to the desired shape.

The geometrically defined surface of the substrate of the optical article onto which the coatings are to be transferred may be a spherical, toric or progressive surface, either coated with functional coatings or uncoated. By geometrically defined surface, it is meant either an optical surface, that is a surface of required geometry and smoothness, or a surface having a required geometry but that still exhibits some roughness, such as a surface that has been grinded and fined, but not polished.

Actually, optical articles such as ophthalmic lenses are classically subjected to a surface mechanical treatment. This mechanical treatment comprises a group of operations leading to the production of a lens having the required geometry, i.e. the desired curvature (optical power). The mechanical treatment typically comprises three successive steps: grinding, fine grinding (also called fining) and polishing.

Grinding is a mechanical processing step intended to create the curvature on a face of the lens substrate.

Fine grinding (fining), performed after grinding further changes the geometry of the treated face of the substrate, which still shows significant surface roughness.

Finally, the polishing, a relatively long mechanical processing step, which usually does not change the geometry of the treated face, removes the remaining roughness as far as possible to give the final transparent substrate.

Thus, the surface of the substrate of the optical article used in the present invention may be polished or only fined without having been polished, but preferably polished. The surface of the substrate may also be in a polished state, i.e. but still have some individualized scratchings.

Typically, the surface roughness Rq of a fined face is is above 0.01 μm and preferably ranges from 0.05 to 1.5 μm.

Rq of the polished face ranges under 0.01 μm, preferably around 0.005 μm.

The geometrically defined surface of the substrate to be coated is not necessarily a naked surface, i.e. a surface free of any deposited coating layer, it can also be a surface already covered with one or more functional coatings, for example an impact-resistant coating (primer coating), an abrasion- and/or scratch-resistant coating (hard coat), a polarized coating, a photochromic coating, a dyeing coating, in particular a primer coating.

A whole main surface of the substrate, or only a portion of which, may be coated using the process according to the present invention. In the case of a lens, the coating stack is preferably transferred onto a geometrically defined surface of the rear (concave) main surface of the substrate. In such a case, the coating transfer process is referred to as a BST (back side transfer) process. Obviously, geometrically defined surfaces of front (convex) main surface or both rear and front surface of the substrate can be coated using the process of the invention.

In the case of a lens, the rear (back) surface (generally the concave face) of the substrate is the surface of the lens substrate which, in use, is the closest to the wearer's eye. The front surface (generally the convex surface) of the lens substrate is the surface of the lens substrate which, in use, is the farthest from the wearer's eye.

The substrate may be made of mineral glass or organic glass, preferably organic glass (polymer substrate). The organic glasses can be made of any material currently used for organic ophthalmic lenses, e.g., thermoplastic materials such as polycarbonates and thermoplastic polyurethanes or thermosetting (cross-linked) materials such as those obtained by polymerization of allyl derivatives such as the allyl carbonates of linear or branched aliphatic or aromatic polyols, such as ethylene glycol bis(allyl carbonate), diethylene glycol bis(2-methyl carbonate), diethylene glycol bis(allyl carbonate), ethylene glycol bis(2-chloroallyl carbonate), triethylene glycol bis(allyl carbonate), 1,3-propanediol bis(allyl carbonate), propylene glycol bis(2-ethylallyl carbonate), 1,3-butenediol bis(allyl carbonate), 1,4-butenediol bis(2-bromoallyl carbonate), dipropylene glycol bis(allyl carbonate), trimethylene glycol bis(2-ethylallyl carbonate), pentamethylene glycol bis(allyl carbonate), isopropylene bisphenol-A bis(allyl carbonate), poly(meth)acrylates and copolymers based substrates, such as substrates obtained by the polymerization of alkyl methacrylates, in particular C₁-C₄ alkyl methacrylates such as methyl (meth)acrylate and ethyl (meth)acrylate, substrates comprising (meth)acrylic polymers and copolymers derived from bisphenol-A, polyethoxylated aromatic (meth)acrylates such as the polyethoxylated bisphenolate di(meth)acrylates, polythio(meth)acrylates, thermosetting polyurethanes, polythiourethanes, polyepoxides, polyepisulfides, as well as copolymers thereof and blends thereof.

Substrates particularly recommended are polycarbonates, for example those made from bisphenol-A polycarbonate, sold for example under the trade names LEXAN® by General Electric or MAKROLON® by Bayer AG, or those incorporating carbonate functional groups, in particular substrates obtained by polymerization or copolymerization of diethylene glycol bis(allyl carbonate), sold under the trade name CR-39® by PPG INDUSTRIES (ORMA® ESSILOR lens).

Among other recommended substrates are substrates obtained by polymerization of thio(meth)acrylic monomers, such as those disclosed in the French patent application FR 2734827.

The substrates may obviously be obtained by polymerizing mixtures of the above monomers. By (co)polymer, it is meant a copolymer or polymer. By (meth)acrylate, it is meant an acrylate or methacrylate.

The geometrically defined surface of the substrate to be coated or the exposed surface of the coating stack borne by the carrier is preferably subjected before step c) to a pre-treatment intended to promote adhesion of the layer of composition capable of allowing adhesion which will be subsequently deposited. The surface subjected to the pre-treatment is the one which undergoes deposition step c).

Any physical or chemical adhesion promoting pre-treatment step can be performed. Preferably, as a pre-treatment step, a high-frequency discharge plasma method, a glow discharge plasma method, a corona discharge treatment, a bombardment with energetic species, for example an electron beam method or an ion beam method (“Ion Pre-Cleaning” or “IPC”) is employed. Such pre-treatments are usually performed under vacuum. An acid or base (NaOH) or solvent pre-treatment may also be used. More preferably, the pre-treatment is a corona discharge treatment.

By energetic species, it is meant species with an energy ranging from 1 to 150 eV, preferably from 10 to 150 eV, and more preferably from 40 to 150 eV. Energetic species may be chemical species such as ions, radicals, or species such as photons or electrons.

The carrier, at least one a main surface of which bears the stack of coatings to be transferred, is a rigid or flexible carrier, preferably a flexible carrier.

When using a rigid carrier, the base curvature of the internal surface of the carrier is preferably the same as the base curvature of the surface of the substrate to be coated. The internal surface of the coated carrier, i.e. its surface which is intended to come into contact with the composition capable of allowing adhesion, inversely replicates the geometry of the surface of the optical article to be coated.

When using a flexible, deformable, carrier, the base curvature of the internal surface of the carrier is preferably higher than the base curvature of the surface of the substrate to be coated, especially when the back (concave) surface of the substrate has to be coated. The internal surface of the coated carrier inversely replicates the geometry of the surface of the optical article to be coated under the pressure applied in step e). In this case, it is only necessary to provide the carrier with a surface, the geometry of which conforms to the general shape of the optical surface of the substrate onto which the coating stack is to be applied, either of concave or convex shape, but it is not necessary that this surface strictly corresponds to the geometry of the substrate surface to be coated. Thus, the same flexible carrier can be used for applying coatings onto substrates having surfaces of different specific geometries.

Generally, the carrier has a spherical shape and two parallel main surfaces, and consequently has an even thickness. It is preferably light transparent, in particular UV-transparent, thus permitting UV curing of UV curable adhesive compositions.

The carrier may be a mold part. Its internal surface may have a relief organized according to a pattern, in other words, may be microstructured and may confer to the final optical article properties imparted by the microstructure (for example anti-reflective properties). Different techniques for obtaining a microstructured mold part are disclosed in WO 99/29494.

The carrier is a removable carrier, i.e. a carrier that is intended to be removed at the end of the coating transfer process, so that only the stack of coatings is transferred to the geometrically defined surface of the substrate after completion of the process. The preferred flexible carriers are thin supporting elements made of a plastic material especially a thermoplastic material. Examples of thermoplastic (co)polymers, which can be used for making the carrier are polysulfones, aliphatic poly(meth)acrylates, such as methyl poly(meth)acrylate, polyethylene, polypropylene, polystyrene, SBM (styrene-butadiene-methyl methacrylate) block copolymers, polyphenylene sulfide, arylene polyoxides, polyimides, polyesters, polycarbonates such as bisphenol A polycarbonate, PVC, polyamides such as the nylons, other copolymers thereof, and mixtures thereof. The preferred thermoplastic material is polycarbonate.

Generally, the removable carrier has a thickness of 0.2 to 5 mm, preferably of 0.5 to 2 mm.

Optionally, the carrier is first coated with a layer of protecting and releasing coating Said layer of protecting and releasing coating is not transferred and stays on the carrier when it is removed during step h).

When present, the optional at least one functional coating borne by the carrier, apart from the anti-reflection coating which is necessarily present, may be selected from, without limitation, an anti-fouling top coat, an anti-abrasion- and/or scratch-resistant coating, an impact-resistant coating, a polarized coating, a photochromic coating, a dyed coating, a printed layer, a microstructured layer.

The coatings are applied onto the surface of the carrier in the reverse order with regard to the desired order of the coating stack on the substrate.

Preferably, the coating stack borne by the carrier comprises the following coatings: an anti-fouling top coat, an anti-reflection coating, an abrasion- and/or scratch-resistant coating, an impact-resistant coating (which can be the antistatic coating itself) and an organic antistatic coating comprising at least one conductive polymer. When present, the anti-fouling top coat, the anti-reflection coating, the abrasion- and/or scratch-resistant coating, and the impact-resistant coating are generally deposited onto the carrier in the order they were cited.

The antistatic coating may be located at different positions in the coating stack. In one embodiment of the invention, it is the outermost coating of the coating stack to be transferred, which means that the outermost coating of the carrier resulting from step c) or a) is the antistatic coating. In other embodiments, it is interleaved between two functional coatings, for instance between an anti-reflection coating and an abrasion- and/or scratch-resistant coating, between an abrasion- and/or scratch-resistant coating and an impact-resistant coating or between an anti-reflection coating and an impact-resistant coating.

In a preferred embodiment, the antistatic coating is deposited onto an impact-resistant coating or an abrasion- and/or scratch-resistant coating borne by the carrier.

Preferably, the antistatic coating is not directly deposited onto the carrier or the optional releasing coating. Still preferably, the antistatic coating is not interleaved between two layers of the anti-reflection coating.

The antistatic coating is not necessarily present on the carrier obtained in step a) of the inventive process. However, if it is not, the composition capable of allowing adhesion is necessarily an organic antistatic coating composition comprising at least one conductive polymer and/or at least one conductive polymer precursor (which can be a monomer, a pre-polymer or a polymer) and at least one binder.

The layer of anti-fouling top coat, which in the finished optical article generally constitutes the outermost coating on the substrate, is a low surface energy top coat. If present, it will generally be coated with the AR coating. It is intended to improve dirty mark resistance of the finished optical article and in particular of the anti-reflection coating.

The anti-fouling top coat is defined as a hydrophobic and/or oleophobic surface coating. The ones preferably used in this invention are those which reduce surface energy of the article to less than 20 mJ/m². The invention has a particular interest when using anti-fouling top coats having a surface energy of less than 14 mJ/m² and even better less than 12 mJ/m².

The surface energy values referred above are calculated according to Owens Wendt method, described in the following document: Owens, D. K.; Wendt, R. G. “Estimation of the surface force energy of polymers”, J. Appl. Polym. Sci. 1969, 51, 1741-1747.

As known in the art, a hydrophobic top coat is a layer having a stationary contact angle with deionized water of at least 60°, preferably at least 75°, more preferably at least 90°, even better more than 100° and ideally more than 110°.

The stationary contact angle with water is determined according to the liquid drop method in which a water drop having a diameter smaller than 2 mm is formed on the optical article and the contact angle is measured.

The anti-fouling top coat according to the invention is preferably of organic nature. By organic nature, it is meant a layer which is comprised of at 30 least 40% by weight, preferably at least 50% by weight of organic materials, relative to the total weight of the coating layer. A preferred anti-fouling top coat is made from a liquid coating material comprising at least one fluorinated compound.

Hydrophobic and/or oleophobic surface coatings most often comprise silane-based compounds bearing fluorinated groups, in particular perfluorocarbon or perfluoropolyether group(s). By way of example, silazane, polysilazane or silicone compounds are to be mentioned, comprising one or more fluorine-containing groups such as those mentioned here above. Such compounds have been widely disclosed in the previous art, for example in Patents U.S. Pat. No. 4,410,563, EP 0203730, EP 749021, EP 844265 and EP 933377.

A classical method to form an anti-fouling top coat consists in depositing compounds bearing fluorinated groups and Si—R groups, R representing an —OH group or a precursor thereof, such as —Cl, —NH₂, —NH— or —O-alkyl, preferably an alkoxy group. Such compounds may perform, at the surface onto which they are deposited, directly or after hydrolysis, polymerization and/or cross-linking reactions with pendent reactive groups.

Preferred fluorinated compounds are silanes and silazanes bearing at least one group selected from fluorinated hydrocarcarbons, perfluorocarbons, fluorinated polyethers such as F₃C—(OC₃F₆)₂₄—O—(CF₂)₂—(CH₂)₂—O—CH₂—Si(OCH₃)₃ and perfluoropolyethers, in particular perfluoropolyethers.

Among fluorosilanes there may be cited the compounds of formulae:

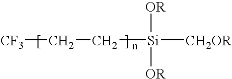

wherein n=5, 7, 9 or 11 and R is an alkyl group, typically a C₁-C₁₀ alkyl group such as methyl, ethyl and propyl;

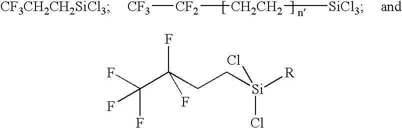

wherein n′=7 or 9 and R is as defined above.

Compositions containing fluorosilanes compounds also useful for making hydrophobic and/or oleophobic top coats are disclosed in U.S. Pat. No. 6,183,872. Such compositions comprise silicon-containing organic fluoropolymers represented by the below general formula and having a number average molecular weight of from 5×10² to 1×10⁵ g/mol.

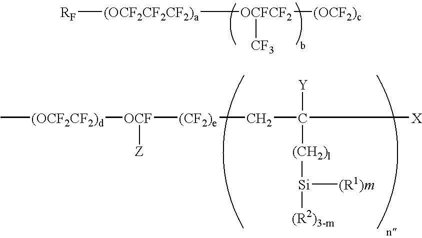

wherein R_{F} represents a perfluoroalkyl group, Z represents a fluorine atom or a trifluoromethyl group, a, b, c, d and e each independently represent 0 or an integer equal to or higher than 1, provided that a+b+c+d+e is not less than 1 and the order of the repeating units parenthesized by subscripts a, b, c, d and e occurring in the above formula is not limited to that shown; Y represents a hydrogen atom or an alkyl group containing 1 to 4 carbon atoms; X represents a hydrogen, bromine or iodine atom; R¹ represents a hydroxyl group or a hydrolyzable substituent group; R² represents a hydrogen atom or a monovalent hydrocarbon group; I represents 0, 1 or 2; m represents 1, 2 or 3; and n″ represents an integer equal to or higher than 1, preferably equal to or higher than 2.

Other preferred compositions for forming the hydrophobic and/or oleophobic surface coating are those containing compounds comprising fluorinated polyether groups, in particular perfluoropolyether groups. A particular preferred class of compositions containing fluorinated polyether groups is disclosed in U.S. Pat. No. 6,277,485. The anti-fouling top coats of U.S. Pat. No. 6,277,485 are at least partially cured coatings comprising a fluorinated siloxane prepared by applying a coating composition (typically in the form of a solution) comprising at least one fluorinated silane of the following formula:

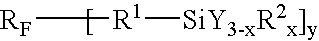

wherein R_{F} is a monovalent or divalent polyfluoro polyether group; R¹ is a divalent alkylene group, arylene group, or combinations thereof, optionally containing one or more heteroatoms or functional groups and optionally substituted with halide atoms, and preferably containing 2 to 16 carbon atoms; R² is a lower alkyl group (i.e., a C₁-C₄ alkyl group); Y is a halide atom, a lower alkoxy group (i.e., a C₁-C₄ alkoxy group, preferably, a methoxy or ethoxy group), or a lower acyloxy group (i.e., —OC(O)R³ wherein R³ is a C₁-C₄ alkyl group); x is 0 or 1; and y is 1 (R_{F} is monovalent) or 2 (R_{F} is divalent). Suitable compounds typically have a molecular weight (number average) of at least about 1000. Preferably, Y is a lower alkoxy group and R_{F} is a perfluoro polyether group.

Commercial compositions for making anti-fouling top coats are the compositions KY130® and KP 801M® (which comprises an organosilazane) commercialized by Shin-Etsu Chemical and the composition OPTOOL DSX® (a fluorine-based resin comprising perfluoropropylene moieties) commercialized by Daikin Industries. OPTOOL DSX® is the most preferred coating material for anti-fouling top coats.

The liquid coating material for forming the anti-fouling top coat of the invention may comprise one or more of the above cited compounds. Preferably, such compounds or mixtures of compounds are liquid or can be rendered liquid by heating, thus being in a suitable state for deposition.

The technique for depositing such anti-fouling top coats onto the carrier are very diverse, including liquid phase deposition such as dip coating, spin coating, spray coating, or vapor phase deposition (vacuum evaporation). Of which, deposition by spin or dip coating is preferred.

If the anti-fouling top coat is applied under a liquid form, at least one solvent is added to the coating material so as to prepare a liquid coating solution with a concentration and viscosity suitable for coating. Deposition is followed by curing.

In this connection, preferred solvents are fluorinated solvents and alcanols such as methanol, preferably fluorinated solvents. Examples of fluorinated solvents include any partially or totally fluorinated organic molecule having a carbon chain with from about 1 to about 25 carbon atoms, such as fluorinated alkanes, preferably perfluoro derivatives and fluorinated ether oxides, preferably perfluoroalkyl alkyl ether oxides, and mixtures thereof. As fluorinated alkanes, perfluorohexane (“Demnum” from DAIKIN Industries) may be used. As fluorinated ether oxides, methyl perfluoroalkyl ethers may be used, for instance methyl nonafluoro-isobutyl ether, methyl nonafluorobutyl ether or mixtures thereof, such as the commercial mixture sold by 3M under the trade name HFE-7100. The amount of solvent in the coating solution preferably ranges from 80 to 99.99% in weight.

Anti-reflection coatings and their methods of making are well known in the art. The anti-reflection coating of the present invention may include any layer or stack of layers which improves the anti-reflective properties of the finished optical article over at least one portion of the visible spectrum, thereby increasing the transmission of light and reducing surface reflectance at the article-air interface.

The anti-reflection coating may be a mono- or multilayered anti-reflection coating, and preferably comprises a mono- or multilayered film of dielectric materials.

Although the anti-reflection coating preferably comprises an alternated stack of low refractive index (LI) and high refractive index (HI) layers, in another embodiment of the invention, LI and HI layers are not necessarily alternated in the AR coating.

As used herein, a low refractive index layer is intended to mean a layer with a refractive index of 1.55 or less, preferably lower than 1.50 and even better lower than 1.45, and a high refractive index layer is intended to mean a layer with a refractive index higher than 1.55, preferably higher than 1.6, more preferably higher than 1.8 and even better higher than 2, both at a reference wavelength of 550 nm. Unless otherwise noted, all refractive indexes indicated in the present patent application are expressed at 25° C. and λ=550 nm.

HI layers are classical high refractive index layers and may comprise, without limitation, one or more mineral oxides such as TiO₂, PrTiO₃, LaTiO₃, ZrO₂, Ta₂O₅, Y₂O₃, Ce₂O₃, La₂O₃, Dy₂O₅, Nd₂O₅, HfO₂, Sc₂O₃,Pr₂O₃ or Al₂O₃, or Si₃N₄, as well as mixtures thereof, preferably TiO₂ or PrTiO₃.

LI layers are also well known and may comprise, without limitation, SiO₂, MgF₂, ZrF₄, AlF₃, chiolite (Na₃Al₃F₁₄]), cryolite (Na₃[AlF₆]), or mixtures thereof, preferably SiO₂ or SiO₂ doped with Al₂O₃.

Generally, HI layers have a physical thickness ranging from 10 to 120 nm, and LI layers have a physical thickness ranging from 10 to 100 nm.

Preferably, the total physical thickness of the anti-reflection coating is lower than 1 micrometer, more preferably lower than or equal to 500 nm and even better lower than or equal to 250 nm. The total physical thickness of the anti-reflection coating is generally higher than 100 nm, preferably higher than 150 nm.

Preferably, the first dielectric material layer (preferably SiO₂) deposited directly on the hydrophilic top coat is deposited using a two stage process in which, in a first stage, a first layer of dielectric material is deposited by vacuum deposition without ionic assistance and thereafter a second layer is deposited by ion assisted vacuum deposition.

The anti-reflection coating is generally applied by vacuum deposition according to one of the following techniques: i) by evaporation, optionally assisted by ion beam; ii) by ion-beam spraying; iii) by cathodic spraying; iv) by chemical vapor deposit assisted by plasma.

In addition to vacuum deposition, the anti-reflection coating can also be applied by depositing a liquid solution, preferably by a spin coating process. As an example, it is possible to apply an inorganic layer by the sol/gel route, for example from a tetraethoxysilane hydrolyzate.

In the case of a single layer film, its optical thickness is preferably equal to λ/4, where λ is a wavelength of 450 to 650 nm.

In the case of a multilayer film comprising three layers, a combination may be used corresponding to the respective optical thicknesses λ/4, λ/2, λ/4 or λ/4, λ/4, λ/4.

It is also possible to use an equivalent coating made up of more layers, instead of any number of the layers which are part of the above-mentioned three layers.

Preferably, the anti-reflection coating is a multilayer film comprising three or more dielectric material layers of alternatively high (HI) and low (LI) refractive indexes.

Optionally, the anti-reflection coating comprises a sub-layer. By “sub-layer” is meant a coating which is generally employed for purposes of adhesion improvement or abrasion and/or scratch resistance improvement. In the present patent application, the AR coating comprises “anti-reflection layers” and optionally comprises a sub-layer. Said sub-layer is considered to be part of the anti-reflection coating, albeit it is not referred to as an “anti-reflection layer.” It is interleaved, in the final optical article, between the substrate (either naked or coated) and the anti-reflection layers of the AR coating, i.e., those having a significant effect on the AR properties of the optical article. Sub-layers generally have a relatively high thickness, and consequently neither take part to the anti-reflective optical activity nor have a significant optical effect.

Sub-layers are sometimes referred to as under-layers, underlying layers, primer layers, basic layers, lower layers, adhesion layers, subbing layers or foundation layers in the literature.

Optionally, the sub-layer may be laminated, i.e., composed of several layers. Mono-layer sub-layers are preferred to multi-layer sub-layers.

It may comprise one or more materials conventionally used for preparing sub-layers, for instance one or more dielectric materials chosen from dielectric materials previously described in the present specification. Preferably, the sub-layer is a SiO₂ based sub-layer, more preferably free of Al₂O₃.

A preferred anti-reflection coating comprises a stack of four layers formed by vacuum deposition, for example a first SiO₂ layer having an optical thickness of about 100 to 160 nm, a second ZrO₂ layer having an optical thickness of about 120 to 190 nm, a third SiO₂ layer having an optical thickness of about 20 to 40 nm and a fourth ZrO₂ layer having an optical thickness of about 35 to 75 nm, the layers being deposited onto the carrier, which may already be coated with one or more coatings, from the fourth to the first (i.e., the reverse order they should be present on the finished optical article).

Preferably, after deposition of the above four-layer anti-reflecting stack, a SiO₂ sub-layer is deposited to promote the adhesion between the anti-reflection stack and the abrasion and/or scratch-resistant coating generally subsequently deposited.

Before applying the subsequent coating onto the AR coating, it is possible to subject the surface of the AR coating to a physical or chemical pre-treatment step such as described above so as to increase adhesion of the layers.

The next layer to be deposited generally is an abrasion and/or scratch-resistant coating.

Any known optical abrasion- and/or scratch-resistant coating composition can be used to form the abrasion- and/or scratch-resistant coating of the invention. Thus, the abrasion- and/or scratch-resistant coating composition can be a UV and/or a thermal curable composition.

By definition, an abrasion- and/or scratch-resistant coating is a coating which improves the abrasion- and/or scratch-resistance of the finished optical article as compared to a same optical article but without the abrasion- and/or scratch-resistant coating. Preferred coating compositions are (meth)acrylate based coatings. The term (meth)acrylate means either methacrylate or acrylate.

The main component of the (meth)acrylate based coating compositions may be chosen from monofunctional (meth)acrylates and multifunctional (meth)acrylates such as difunctional (meth)acrylates; trifunctional (meth)acrylates; tetrafunctional (meth)acrylates, pentafunctional(meth)acrylates, hexafunctional (meth)acrylates.

Other preferred abrasion- and/or scratch-resistant coatings are silicon containing coatings, especially those obtained by curing a precursor composition including silanes or a hydrolyzate thereof, preferably epoxysilanes, and more preferably the epoxyalkoxysilanes disclosed in FR 2702486, WO 94/10230, U.S. Pat. No. 4,211,823 and U.S. Pat. No. 5,015,523.

A particularly preferred composition for an abrasion- and/or scratch-resistant coating is disclosed in FR 2702486. Said preferred composition comprises a hydrolyzate of an epoxytrialkoxysilane and dialkyldialkoxysilane, colloidal mineral fillers and a catalytic amount of an aluminum-based curing catalyst, the remaining of the composition being essentially comprised of solvents typically used for formulating these compositions. A surfactant is also preferably added in the composition so as to improve the optical quality of the deposit.

Especially preferred epoxyalkoxysilane based abrasion- and/or scratch-resistant coating compositions are those comprising as the main constituents an hydrolyzate of γ-glycidoxypropyl-trimethoxysilane (GLYMO) as the epoxytrialkoxysilane component, an hydrolyzate of dimethyl-diethoxysilane (DMDES) as the dialkyldialkoxysilane component, colloidal silica and a catalytic amount of aluminum acetylacetonate.

In order to improve the adhesion of the abrasion- and/or scratch-resistant coating to the impact-resistant primer coating which is generally subsequently deposited, or to the antistatic coating for example, an effective amount of at least one coupling agent can be added to the abrasion- and/or scratch-resistant coating composition. The preferred coupling agent is a pre-condensed solution of an epoxyalkoxysilane and an unsatured alkoxysilane, preferably comprising a terminal ethylenic double bond.

Examples of epoxyalkoxysilanes are GLYMO, γ-glycidoxypropyl-pentamethyldisiloxane, γ-glycidoxypropyl-methyl-diisopropenoxysilane, γ-glycidoxypropyl-methyl-diethoxysilane, γ-glycidoxypropyl-dimethyl-ethoxysilane, γ-glycidoxypropyl-diisopropyl-ethoxysilane and γ-glycidoxypropyl-bis (trimethylsiloxy) methylsilane. The preferred epoxyalkoxysilane is GLYMO.

The unsaturated alkoxysilane can be a vinylsilane, an allylsilane, an acrylic silane or a methacrylic silane. The preferred silane is acryloxypropyl trimethoxysilane.

Preferably, the amounts of epoxyalkoxysilane(s) and unsaturated alkoxysilane(s) used for the coupling agent preparation are such that the weight ratio:

$$R = \frac{weight of epoxyalkoxysilane}{weight of unsaturated alkoxysilane}$$

verifies the condition 0.8≦R≦1.2.

Preferred preparation methods for the coupling agent comprise:

1) mixing the alkoxysilanes; 2) hydrolyzing the alkoxysilanes, preferably by addition of an acid, such as hydrochloric acid; 3) stirring the mixture; 4) optionally adding an organic solvent; 5) adding one or several catalyst(s) such as aluminum acetylacetonate; and 6) stirring (typical duration: overnight).

Typically, the amount of coupling agent introduced in the abrasion and/or scratch-resistant coating composition represents 0.1 to 15% by weight of the total composition weight, preferably 1 to 10% by weight.

The abrasion- and/or scratch-resistant coating composition can be applied, generally onto the AR coating or the antistatic coating using any classical method such as spin, dip or flow coating.

The abrasion- and/or scratch-resistant coating composition can be simply dried or optionally pre-cured before application of a subsequent coating, generally the primer coating or the antistatic coating. Depending upon the nature of the abrasion- and/or scratch-resistant coating composition, thermal curing, UV-curing or a combination of both can be used.

Thickness of the abrasion- and/or scratch-resistant coating, after curing, usually ranges from 1 to 15 μm, preferably from 2 to 6 μm, preferably from 3 to 5 μm.

Before applying the subsequent coating onto the abrasion and/or scratch-resistant coating, it is possible to subject the surface of the abrasion and/or scratch-resistant coating to a pre-treatment step such as described above.

The impact-resistant primer coating which may be used in the present invention can be any coating typically used for improving impact resistance of a finished optical article. Also, this coating generally enhances adhesion, if present, of the abrasion and/or scratch-resistant coating on the substrate of the finished optical article. By definition, an impact-resistant primer coating is a coating which improves the impact resistance of the finished optical article as compared with the same optical article but without the impact-resistant primer coating.

Typical impact-resistance primer coatings are (meth)acrylic based coatings and polyurethane based coatings. (Meth)acrylic based impact-resistant coatings are, among others, disclosed in U.S. Pat. Nos. 5,015,523 and 6,503,631 whereas thermoplastic and cross-linked based polyurethane resin coatings are disclosed inter alia, in Japanese Pat. Nos. 63-141001 and 63-87223, EP Pat. No. 0404111 and U.S. Pat. No. 5,316,791.

In particular, the impact-resistant primer coating according to the invention can be made from a latex composition such as a poly(meth)acrylic latex, a polyurethane latex or a polyester latex.

Among the preferred (meth)acrylic based impact-resistant primer coating compositions there can be cited polyethylene glycol(meth)acrylate based compositions such as, for example, tetraethylene glycoldiacrylate, polyethylene glycol (200) diacrylate, polyethylene glycol (400) diacrylate, polyethylene glycol (600) di(meth)acrylate, as well as urethane (meth)acrylates and mixtures thereof.

Preferably, the impact-resistant primer coating has a glass transition temperature (Tg) of less than 30° C. Among the preferred impact-resistant primer coating compositions, there may be cited the acrylic latex commercialized under the name Acrylic latex A-639 by Zeneca and polyurethane latexes commercialized under the names Witcobond® 240 and Witcobond® 234 by Baxenden Chemicals.

In a preferred embodiment, the impact-resistant primer coating may also include an effective amount of a coupling agent in order to promote adhesion of the primer coating to the optical substrate and/or to the scratch-resistant coating or any other coating. The same coupling agents, in the same amounts, as for the abrasion and/or scratch-resistant coating compositions described above, can be used with the impact-resistant coating compositions.

The impact-resistant primer coating composition can be applied onto the underlying coating using any classical method such as spin, dip, or flow coating.

The impact-resistant primer coating composition can be simply dried or optionally pre-cured before application of a subsequent coating. Depending upon the nature of the impact-resistant primer coating composition, thermal curing, UV-curing or a combination of both can be used.

Thickness of the impact-resistant primer coating, after curing, typically ranges from 0.05 to 30 μm, preferably 0.5 to 20 μm, more particularly from 0.6 to 15 μm, better 0.6 to 5 μm and even better from 0.7 to 1.2 μm.

The functional coating having antistatic properties which may be formed onto the coated carrier in the process according to the invention is an electrically conductive layer. It is organic by nature and comprises, as an antistatic agent, at least one conductive polymer which is either conjugated or not. As used herein, “organic antistatic coating” means that said coating comprises at least one conductive polymer which is organic by nature. By “conductive polymer,” it is meant either a conductive polymer or a conductive copolymer.

The AS coating according to the invention is covered with at least one layer in the final optical article, and is thus protected from outside mechanical and chemical degradations (abrasion, scratch, oxidation, chemical contamination etc.). In one embodiment of the invention, the AS coating also acts as an impact resistant primer.

Among conductive polymers, those leading to thin transparent layers are preferred. As examples of transparent, organic, conductive polymers may be cited polyanilines, such as those disclosed in U.S. Pat. Nos. 5,716,550 and 5,093,439, polypyrroles, such as those disclosed in U.S. Pat. Nos. 5,665,498 and 5,674,654, polythiophenes, such as those disclosed in U.S. Pat. Nos. 5,575,898, 5,403,467 and 5,300,575, polyethylene-imines, polyselenophenes, compounds based on allylamine such as poly(allylamine), polyvinylphenylene, copolymers thereof, derivatives of those polymers and mixtures thereof. They may be employed as mixtures. Other examples of conductive polymers can be found in “Conjugated Polymeric Materials: Opportunities in Electronics, Optoelectronics, and Molecular Enginering”, J. L. Bredas and B. Silbey, Eds., Kluwer, Dordrecht, 1991, which is incorporated herein by reference.

Those conductive polymers are generally employed under a polycationic form (polyaniline cation, polypyrrole cation, polythiophene cation, poly(allylamine) cation . . . ), generally in combination with one or more polyanions. The polyionic compounds may be compounds including a charge in their main chain or compounds including ionizable side groups.

Polyanions, either conjugated or not, represent any type of polymer fitted with ionizable groups, typically within the repeat unit, that are capable of supporting negative charges when ionized. They may be chosen, without limitation, from polymeric carboxylic or sulfonic acids anions (polyacids) and mixtures thereof. For example, polystyrene sulfonate, polyaniline sulfonate, polyvinyl sulfonate, polyacrylate, polymethacrylate, polymaleate, poly(thiophene-3-acetate) anions as well as anions of copolymers obtained by copolymerizing at least one acidic monomer such as acrylic, methacrylic, maleic, styrene sulfonic, or vinyl sulfonic acid with at least another monomer, either acidic or not, may be cited. Among said non acidic monomers, styrene or acrylic esters may be cited. Other examples of polyanions can be found in “Coulombic interactions in Macromolecular Systems” ACS Symposium Series No. 302, A. Eisenberg and F. Bailey Eds., 1986, which is hereby incorporated by reference. The preferred polyanion is polystyrene sulfonate.

The number average molecular weight of polyanion precursor polyacids generally ranges from 1000 to 2.10⁶ g/mol, preferably from 2000 to 500000.

Polyacids can be prepared by known methods or are commercially available, optionally under a metallic salt form.

Preferred conductive polymers are polypyrroles polystyrene sulfonate, in particular the 3,4-dialkoxy substituted polypyrroles derivatives, and polythiophenes polystyrene sulfonate, in particular the 3,4-dialkoxy substituted polythiophenes derivatives, poly(3-alkylthiophenes), and mixtures thereof. Specific examples of preferred conductive polymers are poly(3,4-ethylenedioxythiophene)-poly(styrene sulfonate) and poly(3,4-ethylenedioxypyrrole)-poly(styrene sulfonate).

Conductive polymers are commercially available or may be prepared according to known methods. Polypyrroles polystyrene sulfonate, for example, can be synthesized by oxidation polymerization of pyrroles in aqueous medium, in the presence of poly(styrene sulfonic) acid and ammonium persulfate as an oxidant.

The organic AS coating may be formed at the surface of the coated carrier according to any appropriate method, in particular by liquid or vapor phase deposition, or by lamination. Preferably, said coating is deposited by wet method, preferably by deposition of a liquid antistatic coating composition, comprising at least one conductive polymer, in a so sufficient amount as to impart the desired AS properties, notably to at least one main surface of the final optical article, preferably to both main faces. Application of said composition may be carried out, without limitation, by spin coating, dip coating, spray coating, brush coating, roller coating. Spin coating and dip coating are preferred.

The antistatic coating composition may be a solution or dispersion, both terms being merged in the present patent application. These terms refer to a mixture of components which generally is uniform at the macroscopic scale (visually) and are not related to a particular solubility state or particle size of said components.

The antistatic coating composition preferably comprises a dispersion (or solution) of at least one conductive polymer in an aqueous or organic solvent, or a mixture of these solvents, and optionally one or more binders. The antistatic coating composition is preferably an aqueous dispersion of conductive polymer(s).

Conductive polymers can be substituted with very diverse functional groups, notably hydrophilic groups, preferably ionic or ionizables, such as the following groups: COOH, SO₃H, NH₂, ammonium, phosphate, sulfate, imine, hydrazino, OH, SH or salts thereof. Presence of these functional groups make easier the preparation of an aqueous AS coating composition, since they make conductive polymers more compatible with water and thus more soluble in the composition. This may improve the quality of the deposit.

Generally, the antistatic coating composition contains water, preferably deionized water or a mixture water/water miscible solvent as a solvent. Among useful water miscible solvents may be cited the following alcohols: methanol, ethanol, n-propanol, isopropanol, n-butanol, isobutanol, sec-butanol, tert-butanol, n-amylic alcohol, isoamylic alcohol, sec-amylic alcohol, tert-amylic alcohol, 1-ethyl-1-propanol, 2-methyl-1-butanol, 1-methoxy-2-propanol n-hexanol, cyclohexanol, ethyl cellosolve (monoethoxy ethylene glycol), and ethylene glycol. It is also possible to add an appropriate amount of another hydrophilic organic solvent in said composition in order to improve the dissolution of the AS agent, or increase compatibility of the optional binder with the composition. To this end, organic solvents such as N-methylpyrrolidin-2-one (NMP), acetone, triethylamine or dimethylformamide (DMF) may be employed, without being limited to this solvent list. However, the antistatic coating composition preferably only comprises environmentally benign solvents, such as water or ethanol.

Preferred conductive polymers are water soluble or water dispersible, or soluble or dispersible in an alcohol or a mixture water/alcohol, so as to be able to be applied through a composition onto the coated carrier.

As an example of commercially available antistatic coating composition which is a conductive polymer dispersion may be cited Baytrone P, based on polythiophene, developed by Bayer and commercialized by H. C. Starck. It is an aqueous dispersion of the polymer complex poly(3,4-ethylenedioxythiophene)-poly(styrene sulfonate), abbreviated as PEDT/PSS, which contains 1.3% by weight of conductive polymer-PSS. Said composition leads to antistatic films which are inexpensive to produce, have a very good temperature resistance and are compatible with many material systems.

The antistatic coating composition may optionally comprise at least one binder. The binder can be any film-forming material. “Binder” is defined as a compound capable of improving adhesion of the AS coating to the underlying layer and/or the upper layer, and/or integrity of the antistatic coating. Presence of a binder may allow strengthening abrasion and/or scratch resistance of the final optical article, depending on the binder nature.

The binder has to be compatible with the AS agent, i.e. not be detrimental to its AS properties, form a stable solution by avoiding precipitation of said agent or aggregation thereof in more or less big particles, which would generate optical flaws.

The choice of the binder is generally determined by the employed system of solvents in the coating composition, for it has to be soluble or dispersible in said system of solvents.

The binder preferably is a polymer material, generally organic. It may be formed from a thermoplastic or thermosetting material, optionally cross-linkable through polycondensation, polyaddition or hydrolysis. Mixtures of binders from different categories may also be employed.

Binders are preferentially soluble or dispersible in water or in an aqueous composition such as a hydro-alcoholic composition. Among water soluble or dispersible binders may be cited homopolymers or copolymers of the following monomers: styrene, vinylidene chloride, vinyl chloride, alkyl acrylates, alkyl methacrylates, (meth)acrylamides, polyester homopolymers or copolymers, poly(urethane-acrylate), poly(ester-urethane), polyether, vinyl polyacetate, polyepoxyde, polybutadiene, polyacrylonitrile, polyamide, melamine, polyurethane, polyvinylic alcohol, copolymers thereof, and mixtures thereof. Among poly(meth)acrylate binders may be cited poly(methyl methacrylate).

The binder may be a water soluble polymer, or may be used under a latex form or a mixture of latexes.

As it is well known, latexes are stable dispersions of particles of at least one polymer in an aqueous medium. Preferred latexes are polyurethane latexes, poly(meth)acrylic latexes, polyester latexes and mixtures thereof. The latex may comprise hydrophilic functional groups such as sulfonic or carboxylic acid groups. As examples, polyester sulfones, such as the aqueous composition Eastek® 12100-02-30% commercialized by Eastman Chemical Company, and polyurethane sulfones may be cited. Optionally, the latex is of the core-shell type.

Poly(meth)acrylic latexes are generally latexes of copolymers mainly formed from (meth)acrylate monomers, such as for example ethyl, butyl, methoxyethyl or ethoxyethyl (meth)acrylate, and generally from a minor amount of at least another co-monomer, such as for example styrene.

Preferred poly(meth)acrylic latexes are acrylate-styrene copolymer latexes, which are commercially available from ZENECA RESINS under the trade name NEOCRYL®, such as NEOCRYL® A-639, or from B. F. Goodrich Chemical Co. under the trade name CARBOSET®, such as CARBOSET® CR-714.

Preferred polyurethane latexes are polyurethane latexes comprising polyester moieties, preferably aliphatic polyester moieties. Still preferably, polyurethane units are obtained by polymerizing at least one aliphatic polyisocyanate with at least one aliphatic polyol. Those latexes provide antistatic coatings based on polyurethane having polyester moieties.

Such polyurethane-polyester latexes are commercially available from ZENECA RESINS under the trade name Neorez® (e.g., Neorez® R-962, Neorez® R-972, Neorez® R-986, Neorez® R-9603) or BAXENDEN CHEMICALS, a subsidiary of WITCO Corporation, under the trade name Witcobond® (e.g., Witcobond® 232, Witcobond® 234, Witcobond® 240, Witcobond® 242). Other commercially available polyurethane latexes are Bayhydrol® 121 or Bayhydrol® 140AQ, commercialized by H. C. Starck.

Another binder category which may be used in the antistatic coating composition comprises binders based on functionalized silane, siloxane or silicate (alkali metal salt of a Si—OH compound), or hydrolyzates thereof. They are generally substituted with one or more functional organic groups and form silica organosols. As binders, they may also act as adhesion promoters toward organic or mineral glass substrates. These binders may also act as cross-linking agents toward conductive polymers used under the form of polystyrene sulfonate salts and the like.

As silicon containing binders may be cited silanes or siloxanes bearing an amine group such as amino alkoxysilanes, hydroxy silanes, alkoxysilanes, preferably methoxy or ethoxy silanes, for example epoxy alkoxysilanes, ureidoalkyl alkoxysilanes, dialkyl dialkoxysilanes (for example dimethyl diethoxysilane), vinylsilanes, allylsilanes, (meth)acrylic silanes, carboxylic silanes, polyvinylic alcohols bearing silane groups, tetraethoxysilane, and mixtures thereof.

After having been subjected to hydrolysis, the above cited organofunctional binders generate interpenetrated networks by forming silanol groups, which are capable of establishing bonds with the upper layer and/or the underlying layer.

Amino alkoxysilane binders may be chosen from, without limitation: 3-amino propyl triethoxy silane, 3-amino propyl methyl dimethoxy silane, 3-(2-amino ethyl)-3-amino propyl trimethoxy silane, amino ethyl triethoxysilane, 3-(2-amino ethyl) amino propyl methyl dimethoxy silane, 3-(2-amino ethyl)-3-amino propyl triethoxy silane, 3-amino propyl methyl diethoxysilane, 3-amino propyl trimethoxysilane, and combinations thereof.

Ureidoalkyl alkoxysilane binders may be chosen from, without limitation: ureidomethyl trimethoxysilane, ureidoethyl trimethoxysilane, ureidopropyl trimethoxysilane, ureidomethyl triethoxysilane, ureidoethyl triethoxysilane, ureidopropyl triethoxysilane, and combinations thereof.

Among silicon containing binders, the binder preferably is an epoxy alkoxysilane, better an alkoxysilane bearing a glycidyl group, and still better a trialkoxysilane bearing a glycidyl group. Among these compounds may be cited glycidoxy methyl trimethoxysilane, glycidoxy methyl triethoxysilane, glycidoxy methyl tripropoxysilane, α-glycidoxy ethyl trimethoxysilane, α-glycidoxy ethyl triethoxysilane, β-glycidoxy ethyl trimethoxysilane, β-glycidoxy ethyl triethoxysilane, β-glycidoxy ethyl tripropoxysilane, α-glycidoxy propyl trimethoxysilane, α-glycidoxy propyl triethoxysilane, α-glycidoxy propyl tripropoxysilane, β-glycidoxy propyl trimethoxysilane, β-glycidoxy propyl triethoxysilane, β-glycidoxy propyl tripropoxysilane, α-glycidoxy propyl trimethoxysilane, γ-glycidoxy propyl triethoxysilane, γ-glycidoxy propyl tripropoxysilane, hydrolyzates thereof, and mixtures thereof. γ-glycidoxy propyl trimethoxysilane (GLYMO), which is commercialized among others by Merck, is a binder which is particularly suited to the invention.

Other examples of useful alkoxysilanes bearing a glycidyl group are γ-glycidoxypropyl pentamethyl disiloxane, γ-glycidoxypropyl methyl diisopropenoxy silane, γ-glycidoxypropyl methyl diethoxysilane, γ-glycidoxypropyl dimethyl ethoxysilane, γ-glycidoxypropyl diisopropyl ethoxysilane, γ-glycidoxypropyl bis(trimethylsiloxy)methylsilane, and mixtures thereof.

The above cited binders are only examples of binders which may be used in the invention, which is not limited to that list. The person skilled in the art will easily recognize other categories of compounds which may be used as binders of the present antistatic coating composition.

Some antistatic coating compositions comprising a binder and a conductive polymer are commercially available and can be used in the invention, such as for example composition D 1012 W (aqueous dispersion of polyaniline), commercialized by Ormecon Chemie GmbH, or the following compositions based on the Baytron® P dispersion, all commercialized by H. C.

Starck: CPUD-2 (polyurethane binder), CPP 105D (GLYMO binder), CPP 103D (aliphatic polyester-polyurethane binder), CPP 116.6D and CPP 134.18D (polyurethane+GLYMO binders). A preferred coating composition is composition CPP 105D, which dry extract is around 1.5% by weight. It leads to AS coatings having good adhesion properties to organic or mineral glass substrates.

Another preferred coating composition is a composition based on the Baytron® P dispersion further comprising a polyurethane latex as a binder precursor, most preferably Witcobond® 240 or 234. Said coating composition generally comprises a 0.9:1 to 2.5:1 weight ratio of Baytron® P /Witcobond® 240 or 234.

According to a particular embodiment of the invention, the antistatic coating composition does not comprise any binder.

When the AS coating composition comprises a binder, it may be cross-linked or cured owing to the presence of at least one cross-linking agent which preferably is soluble or dispersible in water. These cross-linking agents are well known and react with functional groups of the binder, such as carboxyl or hydroxyl groups. They may be chosen from polyfunctional aziridines, methoxyalkylated melamine or urea resins, for example methoxyalkylated melamine/formaldehyde and urea/formaldehyde resins, epoxy resins, carbodiimides, polyisocyanates, triazines and blocked polyisocyanates. Preferred cross-linking agents are aziridines, in particular trifunctional aziridines.

Particularly recommended polyfunctional aziridines are commercialized under the trade name Neocryl CX-100® by ZENECA RESINS, XAMA-7® (pentaerythritol-tris-(β-(N-aziridinyl)propionate)) and XAMA-2® (trimethylolpropane-tris-(β-(N-aziridinyl)propionate)) by B. F. Goodrich Chemical Co.

A cross-linking agent of the polyisocyanate type which is dispersible in water is commercialized by UNION CARBIDE under the trade name XL-29 SE®. A cross-linking agent of the carbodiimide type which is dispersible in water is commercialized by BAYER under the trade name XP 7063®, and a cross-linking agent of the methoxymethylmelamine type is commercialized by CYTEC under the trade name CYMES® 303.

The antistatic coating composition may comprise additives classically employed in this type of composition, such as anti-oxidants, stabilizers, UV absorbers, doping agents such as organic acids, ionic or non ionic surfactants, adhesion promoters or pH regulators (particularly in the case of AS agents such as polypyrroles or polyanilines). They should neither decrease the effectiveness of the AS agent nor deteriorate optical properties of the article.

As examples of pH regulators may be cited acetic acid or an aqueous solution of N,N-dimethyl ethanolamine.

The antistatic coating composition according to the invention generally has a dry extract (ratio of total weight of solid compounds after evaporation of solvents/total weight of the composition) lower than 50%, preferably ranging from 0.2 to 30%, even better from 0.2 to 15%, which includes both required compounds (antistatic agents) and optional compounds.

Although the amount of solid conductive polymers and/or conductive polymer precursors in the coating composition is not particularly limited, it preferably ranges from 0.1 to 20% by weight, more preferably from 0.1 to 5%, better from 0.1 to 0.5% and even better from 0.15 to 0.35%. Beyond 20% by weight, the AS coating composition is generally too viscous and the resulting antistatic coating may show transmittance lower than 85%, while below 0.1%, the composition may be too diluted and the resulting coating may not exhibit antistatic properties.

Preferably, the binder, when present, is used in such an amount that the ratio of total weight of solid binder components/total weight of the composition ranges from 2 to 7%, preferably from 3 to 5%.

Preferably, the ratio of total weight of solid conductive polymers and/or conductive polymer precursors/total weight of solid binder components in the coating composition ranges from 2 to 20%, preferably from 5 to 12%.

After application of the antistatic coating composition onto the coated carrier, no migration or penetration of the conductive polymer in the underlying coating is observed. The composition may then be dried or cured, if necessary, according to any appropriate method, for example drying with air, in an oven or by using a drier, so as to provide a conductive transparent film. Generally, a temperature of 50-200° C. is employed. A higher temperature and/or a longer drying/curing step sometimes allow to improve adhesion of the AS coating to the underlying coating. The drying/curing step comprises evaporation of the solvents and solidification of the optional binder. In the case of cross-linkable binders, the deposited composition is exposed to an appropriate energy source so as to initiate polymerization and curing of the binder.

According to a particular embodiment, if another coating has to be deposited onto the just deposited antistatic composition layer, said composition must not be subjected to a thermal or UV curing step before deposition of the subsequent upper coating, for example a primer layer. Its curing (or drying) can be performed simultaneously with that of the upper coating.

It is worth noting that an antistatic coating comprising at least one conductive polymer can also be formed by (co)polymerizing in the gaseous phase precursor monomers of said polymer, for example thiophene, furane, pyrrole, selenophene and/or derivatives thereof, especially 3,4-ethylenedioxythiophene, according to the processes such as the one described in EP 1521103. According to this process, an oxidizing agent layer (catalyst) is first deposited onto the coated carrier and then contacted with vaporized precursor monomers of the conductive polymer.

Another technique for obtaining an antistatic coating of the conductive polymer type involves using a coating composition comprising precursor monomers of said conductive polymer or a polymer precursor and a means for polymerizing those monomers or converting the polymer precursor to a conductive polymer, for example an oxidizing agent, typically a Fe(III) salt or soluble polyvinylphenylene precursor. In this case, formation of the conductive polymer is carried out directly on the carrier. Said composition may optionally contain a binder and additives such as described previously.

As explained previously, once the antistatic coating has been obtained that comprises at least one conductive polymer and optionally at least one cured binder, additional coatings may be deposited onto said antistatic coating, for example an impact resistant primer coating and/or an abrasion and/or scratch resistant coating.

Several successive depositions of antistatic layers according to the invention may be performed at the surface of the carrier. In the case when those depositions are carried out by wet method, a single drying step of the whole antistatic stack is preferably performed.

Thickness of the AS coating in the final optical article preferably ranges from 5 to 5000 nm, more preferably from 5 to 3000 nm, even more preferably from 5 to 1000 nm, better from 10 to 500 nm, even better from 20 to 500 nm and is preferably the same as the thickness of the AS coating borne by the carrier. Such thickness ranges ensure obtaining a transparent coating. In addition, limiting thickness of the AS coating allows in some cases to improve adhesion of an impact-resistant primer.

If the thickness of the AS coating becomes too high, the relative transmission factor of light in the visible range of the optical article may significantly drop, given that most conductive polymers absorb in the visible range. The PEDT/PSS polymer, for example, absorbs high wavelengths of the visible range (near IR). A too thick film made of this polymer will consequently have a bluish color. On the contrary, if thickness of the AS coating is too thin, it does not exhibit antistatic properties.

Typically, the total thickness of the stack of coatings borne by the carrier to be transferred is from 1 to 500 μm, but is preferably less than 50 μm, more preferably less than 20 μm, or even better 10 μm or less.

The layer of composition capable of allowing adhesion mentioned in step d) is either formed onto the stack of coatings borne by the carrier, or onto the geometrically defined surface of the substrate onto which the coatings are transferred, preferably onto the stack of coatings of the carrier. It should not impair the optical properties of the final optical article.

In the remaining of the present disclosure, it will be referred to as “the composition capable of allowing adhesion” or, when appropriate, “the adhesive composition.”

Said composition capable of allowing adhesion for use in the coating transfer process is a curable coating composition which may be thermally-curable (heat-curable) or cured through light irradiation (light-curable or radiation-curable), in particular UV irradiation, or both heat- and light-curable. Such curing step is carried out in certain cases during step f) of the inventive process and results in a safe bonding of the coating stack borne by the carrier to the substrate of the optical article.

Of course, if the outermost coating borne by the carrier of the coating exhibits adhesion properties, for example is a pressure sensitive adhesive (PSA), the deposition of a composition capable of allowing adhesion is not necessary and the requirements of step c) of the inventive process are considered to be fulfilled.

The composition capable of allowing adhesion may be deposited by any of the techniques known in the art, such as dip coating, flow coating, spin coating or dry transfer. When liquid, it may be dispensed as at least one drop at the center of the geometrically defined surface of the substrate or the exposed surface of the coating stack to be transferred, or as a specific pattern of drops or as a random pattern of drops, spread out firstly by spin coating or sprayed using a precision dispensing valve.

As used herein, the deposited layer of composition capable of allowing adhesion has not necessarily a continuous structure. It can have a discontinuous structure, for example when several drops of liquid are deposited at different locations of the deposition surface.

An important requirement is that, in the course of the pressure application step e), the composition capable of allowing adhesion be regularly spread on the entire geometrically defined surface of the optical article so that, after the optional heating or curing step, there is formed a coating layer or an adhesion interlayer covering the entire geometrically defined surface of the optical article. Consequently, the deposited amount of said composition must be sufficient.

Preferably, the composition capable of allowing adhesion forms at the beginning of step d) a layer having an even thickness. By even thickness, it is meant that the variation of thickness over the entire layer area has no consequence on the optical power of the final optical article.

The amount of said composition must also be sufficient to at least fill up the grooves (when present) of the surface roughness of the optical article and form a final uniform layer.

Concomitantly, the amount of said composition shall be kept as low as possible to prevent large overflowing of the composition at the periphery of the optical article for avoiding an additional cleaning step to eliminate the excess of said composition.

Said layer of composition capable of allowing adhesion may be formed according to four preferred embodiments, though other methods are available to the person skilled in the art.

According to the first preferred embodiment, the composition capable of allowing adhesion is an adhesive curable coating composition.

Said adhesive curable composition can be any curable adhesive composition or curable glue composition that will achieve, after curing, adhesion by forming an adhesive interlayer between the transferred coating stack and the surface of the optical article.

In particular, the adhesive curable composition can be any classical liquid curable composition typically used for forming functional coating layers for improving the optical and/or mechanical properties of an optical article, in particular an ophthalmic lens. For example, a primer coating composition for improving adhesion and/or impact resistant, an abrasion and/or scratch resistant coating composition, as well as other coatings compositions such as a polarized coating composition and a photochromic or dyeing coating composition can serve as a composition capable of allowing adhesion if they have adhesive properties.

Obviously, if a functional coating, for instance a primer coating, is employed as a composition capable of allowing adhesion, said functional coating need not to be present on the coated carrier provided in step a) of the inventive process.

The liquid curable glue or adhesive composition may comprise, without limitation, polyurethane compounds, epoxy compounds or (meth)acrylate compounds.

Preferred components of the liquid curable adhesive composition are acrylate compounds such as polyethylene glycol di(meth)acrylates, ethoxylated bisphenol A di(meth)acrylates, various trifunctional acrylates such as ethoxylated trimethylolpropane triacrylate and tris(2-hydroxyethyl)isocyanurate. Monofunctional acrylates such as isobornyl acrylate, benzyl acrylate, phenylthioethyl acrylate are also suitable. The above compounds can be used alone or in combination.

Suitable glues are commercially available from the Loctite company.

The composition capable of allowing adhesion is preferably a liquid curable adhesive composition selected from the group consisting of pressure-sensitive adhesives (PSA) and hot-melt adhesives (HMA). In those cases, deposition step c) of the adhesive composition further comprises an additional step in which the deposited layer of adhesive composition is brought to a state in which it becomes unflowable under the process conditions, if said layer was not already in such a state at the end of step c). This means that, at least before moving step d) and pressing step e), the adhesive composition layer, if necessary, has been pre-cured or dried to a hardened state such that the layer will not be significantly spreadable over the deposition surface, in particular under the pressing and optional curing steps of the invention process. As a result, a dry PSA or HMA coating capable of allowing adhesion is obtained.

By “pressure-sensitive adhesive” (sometimes designated as “self-adhesive material”), it is meant a category of adhesives which are permanently tacky in dry form (solvent-free) at room temperature or at temperature of use. They are characterized by their ability to firmly adhere to a variety of dissimilar surfaces under a slight pressure by forming Van der Waals bonds with said surfaces. In any case, no other external energy (such as temperature, solvent, UV . . . ) but pressure is compulsory to form the adhesive joint. However, other external energy may be used to enhance the adhesive performance. PSAs are available into three forms: solvent born, water born (latex) and the form obtained by hot melt process.

A PSA based adhesive coating may be formed by evenly applying a PSA composition on either a geometrically defined surface of the substrate or the exposed surface of the coating stack borne by the carrier, followed by drying to an unflowable state by heating at a temperature typically ranging from 40 ° C. to 130° C.

When the composition allowing adhesion is selected from the group consisting of PSA compositions, applying heat during pressing step e) is only optional.

The families of PSAs are classified according to the main elastomer used in the adhesive formulation. The main families which may be used in the present invention are: natural rubber based PSAs, polyacrylates based PSAs (such as polyethylhexyl acrylate, poly n-butyl acrylate), styrenic block copolymers based PSAs [such as Styrene-Isoprene (SI), Styrene-Isoprene-Styrene (SIS), Styrene-Butadiene (SB), Styrene-Butadiene-Styrene (SBS)], and mixtures thereof. Styrene-butadiene random copolymers, butyl rubber, polyisobutylene, silicon polymers, synthetic polyisoprene, polyurethanes, polyvinyl ethyl ethers, polyvinyl pyrrolidone, and mixtures thereof, may also be used as main components for PSA formulations. For additional examples, see Sobieski et al., Handbook of Pressure-Sensitive Adhesive Technology, 2nd ed., pp. 508-517 (D. Satas, ed.), Van Nostrand Reinhold, New York (1989), incorporated by reference in its entirety.

The PSAs used in this invention are preferably selected from polyacrylate based PSAs and styrenic block copolymers based PSAs.

By “hot-melt adhesive”, it is intended to mean a room temperature solid but flexible adhesive, which melts or drops in viscosity upon heating, and rapidly sets with cooling to create bonds, optionally in a reversible manner. An important property of HMAs is the ability to solidify or congeal or “set” very rapidly under normal ambient conditions, preferably almost instantaneously, when cooling down from the application temperature. They are available in dry form, or in solvent and latex based forms.

A HMA based adhesive coating may be formed by evenly applying a liquid HMA composition on either a geometrically defined surface of the substrate or the exposed surface of the coating stack borne by the carrier, followed by drying to an unflowable state by heating at a temperature typically ranging from 40° C. to 130° C.

Alternatively, a HMA based adhesive coating may be formed from a dry HMA composition by softening said composition by heating to the temperature where it will flow readily, then applying it to either a geometrically defined surface of the substrate or the exposed surface of the coating stack borne by the carrier, and finally hardening it by cooling.

When the composition allowing adhesion is a HMA composition, heat has to be applied during pressing step e) to obtain a good adhesion. Preferably, the HMA layer used in the present invention will not be flowable after heating of step e) because it is laminated in very tight conditions. So the variation of thickness of the adhesive layer in the final optical article, once the coatings are transferred, will typically be less than 2 microns.

Examples of polymers, which can be used in HMA compositions are solvent-free polyamides, polyethylene, polypropylene and other olefin-type polymers, polyurethanes, polyvinyl pyrrolidones, polyesters, poly(meth)acrylic systems, other copolymers thereof, and mixtures thereof. The hot-melt adhesives according to the invention are preferably selected from dry poly(meth)acrylic latexes, such as the acrylic latex commercialized under the name Acrylic latex A-639 by Zeneca, dry polyurethane latexes, such as the latexes commercialized under the names Witcobond® 240 and Witcobond® 234 by Baxenden, dry polyester latexes and mixtures thereof. Preferred latexes are polyurethane latexes. Other preferred latexes are core/shell latexes such as those described in U.S. Pat. No. 6,503,631 to Essilor and especially latexes based on alkyl (meth)acrylates such as butyl (meth)acrylate.

As is known in the art, if a polymer or polymer blend does not have the properties of a PSA or a HMA per se within the meaning of these terms as used herein, it can function as a PSA or a HMA by admixture with small quantities of additives for adjusting the tack (tackifiers), rheology characteristics (including viscosity, thixotropy, and the like), adhesive bond strength characteristics, rate of “set”, low temperature flexibility etc.

The adhesive curable coating composition according to the first preferred embodiment may also include additives such as an effective amount of a coupling agent (as defined above) in order to promote adhesion with the materials with which it will be contacted, classical dyes, a photochromic dyes and/or pigments.

In the final optical article, the thickness of the adhesive coating resulting from the above described curable coating composition is preferably less than 100 μm, more preferably ranges from 0.5 to 50 μm, better from 1 to 20 μm, still better from 1 to 10 μm, and is typically of 1-3 μm.

In a second preferred embodiment of the invention, the composition capable of allowing adhesion is a dry latex layer which will be activated with at least one drop of an aqueous composition, typically an aqueous solvent.

According to that embodiment, deposition step c) comprises the following steps:

c1) forming, either onto the exposed surface of the coating stack borne by the carrier or the at least one geometrically defined surface of the substrate, a layer of a dry latex as a layer of a composition capable of allowing adhesion;

c2) depositing at least one drop of an aqueous composition either onto said at least one geometrically defined surface of the substrate, the exposed surface of said coating stack or onto the surface of the dry latex layer;

In this case, pressing step e) comprises:

e) pressing together the at least one geometrically defined surface of the substrate and the exposed surface of said coating stack, so as to spread the aqueous composition and form a thin pellicle of the aqueous composition between the dry latex layer and either the substrate or the exposed surface of the coating stack borne by the carrier;

During pressing step e), a pressure is exerted generally to the carrier, so that the dry latex layer and aqueous composition drop are brought into contact, if they were not already.

According to that second preferred embodiment of the invention, a heating step f) is performed so as to obtain adhesion in the final optical article:

f) heating the thin pellicle of aqueous composition and the dry latex layer during pressing step (e);

The dry latex layer may be formed by applying liquid latex either onto the exposed surface of the coating stack borne by the carrier, or onto at least one geometrically defined surface of the substrate. Application can be performed by any usual process such a dip coating, flow coating or spin coating. Thereafter, the deposited liquid latex layer is dried at room temperature or by heating. Usually, heating is performed at a temperature ranging from 40° C. to 130° C. and is preferably pursued until at least a tack free layer is obtained. Typically, heating lasts for 15 seconds to 15 minutes, from 60 to 100° C.

Latexes usable for forming the dry latex layer correspond to latexes which may be employed as binders for functional antistatic coating compositions and have been described previously.

Preferred latexes are (meth)acrylic latexes such as the acrylic latex commercialized under the name Acrylic latex A-639 by Zeneca, polyurethane latexes such as the latexes commercialized under the names Witcobond® 240 and Witcobond® 234 by Baxenden and polyester latexes. Most preferred latexes are polyurethane latexes.

Other preferred latexes are core/shell latexes such as those described in U.S. Pat. No. 6,503,631 in the name of the applicant and especially latexes based on alkyl (meth)acrylates such as butyl acrylate or butyl methacrylate.

In a preferred embodiment, the latex layer also includes an effective amount of a coupling agent (as previously defined) in order to promote adhesion of the latex layer with the substrate and/or the exposed surface of the coating stack borne by the carrier, in particular an abrasion and/or scratch-resistant coating, a primer coating or an antistatic coating.

The latexes may also comprise a classical dye or a photochromic dye. Latexes comprising a photochromic dye and methods for obtaining them are disclosed for example in the following patents: EP 1161512; U.S. Pat. No. 6,770,710; U.S. Pat. No. 6,740,699, all in the name of the applicant.

Generally, after drying and curing, the latex layer has a thickness ranging from 0.05 to 30 μm, preferably from 0.5 to 20 μm and better from 0.6 to 15 μm.

The latex layer may preferably constitute an impact-resistant primer coating in the final optical article. In this case, the latex layer preferably fulfills the preferred requirements of impact resistant primer coating, such as Tg (glass transition temperature) of the latex layer being less than 30° C.

Cured latexes, in particular polyurethane latexes, having a low glass transition temperature are preferred since they provide a better transfer and a better adhesion. Thus, the dry latex layer preferably has a Tg lower than 0° C., more preferably lower than −10° C., better lower than −20° C. and even better lower than −40° C.

Also, latexes having low “tacky” temperatures are preferred. Thus, preferred latexes have “tacky” temperatures≦80° C., generally ranging from 40° C. to 80° C. preferably from 50° C. to 75° C.

The aqueous composition, at least one drop of which is deposited in step c2) of the inventive process, can be seen as an activating liquid, i.e., a liquid which, when contacting the dry latex layer under the processing conditions, in particular under heating, imparts to the dry latex layer adhesive properties.

The aqueous composition capable of activating the dry latex layer may be an aqueous solvent. It may be water, preferably deionized water, or a mixture of water and one or more classical organic solvents such as alkanols, typically C₁-C₆ alkanols such as for example methanol or ethanol. Preferably, the aqueous solvent does not comprise any organic solvent.

The activating aqueous composition can also be a latex composition, preferably a mixture of an aqueous solvent and a latex, such as preferably a polyurethane latex. In preferred embodiments, the latex used as an activating aqueous composition has a maximum dry extract of 20% by weight and better of maximum of 15% by weight.

The latexes usable as activating aqueous compositions are preferably the same as the latexes used for making the dry latex layer.

The amount of aqueous composition must be sufficient to form a continuous thin pellicle, preferably over the entire dry latex layer during the application process.

Typically, at least one drop of aqueous composition is deposited at the center of the geometrically defined surface of the substrate (when it is not coated with the dry latex layer), the exposed surface of the coating stack to be transferred (when it is not coated with the dry latex layer), or onto the surface of the dry latex layer itself. Of course, a random pattern of several drops of aqueous composition can also be used.

In the final optical article, the thickness of the adhesive coating resulting from the above described latex layer is preferably less than 100 μm, more preferably ranges from 1 to 50 μm, better from 1 to 25 μm, still better from 1 to 10 μm, and is typically of about 5 μm.

This second preferred embodiment is disclosed extensively in U.S. patent application Ser. No. 11/048,136 filed on Feb. 1, 2005, which is incorporated herein by reference.

According to the two first described preferred embodiments, seeing that the composition capable of allowing adhesion is not an antistatic composition, the stack of coatings borne by the removable carrier of step a) further comprises, in addition to the anti-reflection coating, an organic antistatic coating comprising at least one conductive polymer.

The third and fourth preferred embodiments described hereinafter are dedicated to antistatic compositions capable of allowing adhesion. As a result, the stack of coatings borne by the removable carrier in step a) of the inventive process need not comprise an organic antistatic coating comprising at least one conductive polymer, although it may comprise such antistatic coating.

According to the third preferred embodiment, the composition capable of allowing adhesion is a curable organic antistatic coating composition comprising at least one conductive polymer, and/or at least one polymer precursor (which can be under a monomeric, pre-polymeric or polymeric form), and at least one binder.

After curing, said composition capable of allowing adhesion will achieve adhesion by forming an adhesive interlayer between the transferred coating stack and the surface of the optical article.

Such antistatic coating compositions further comprising a binder which are usable herein have been described previously. Preferably, the antistatic composition capable of allowing adhesion, which can be seen as a glue, comprises at least one binder used under a latex form, more preferably a polyurethane latex. The most preferred binders are Witcobond® 240 and Witcobond® 234.

In the final optical article, the thickness of the antistatic adhesive coating resulting from the above described antistatic composition capable of allowing adhesion preferably ranges from 5 to 500 nm, more preferably from 10 to 200 nm and even better from 20 to 100 nm.

According to the fourth preferred embodiment, which only is slightly different from the second one, the composition capable of allowing adhesion is a dry latex layer such as described above which may be activated with an aqueous composition, and which further comprises at least one conductive polymer.

According to this embodiment, an organic antistatic coating being a dry latex layer is formed either onto the carrier as an outermost coating or onto the geometrically defined surface of the substrate. Then, at least one drop of an aqueous composition may be deposited such as described above in the frame of the second embodiment of the invention. The activating aqueous composition may be an aqueous solvent or a latex composition, for example it may be the same aqueous composition as the one which was used for making the antistatic dry latex layer.

It is worth noting that an antistatic latex composition may also be used to activate a dry latex layer which does not comprise a conductive polymer and simultaneously provide antistatic properties to the whole stack.

Methods for preparing the present organic antistatic coating being a dry latex layer have been described previously in the frame of the second preferred embodiment. Components thereof have also been previously described individually.

In the final optical article, the thickness of the antistatic adhesive coating resulting from the above described antistatic latex layer preferably ranges from 20 to 1000 nm, more preferably from 100 to 800 nm, and even better from 200 to 500 nm.

The force applied in pressing step e) of the inventive process shall only be sufficient for spreading the deposited composition (if it was not already spread) but insufficient to impart any deformation to the substrate. It can be obtained by applying pressure, in particular air pressure or vacuum to the external surface of the carrier (i.e. the surface of the carrier which is not in contact with the composition allowing adhesion). Preferably, the pressure is first applied on the center part of the carrier and in a second step the pressure is radially increased towards the periphery of the substrate.

The applied pressure will depend on the sizes and curvatures of the substrate and carrier. Of course, the pressure needs to be maintained onto the carrier and substrate till enough adhesion of the coating stack to the substrate is obtained.

The exerted pressure will typically range from 0.35 to 4.2 bars (5 to 60 psi), preferably 0.35 to 3 bars and better 0.35 to 2.1 bars (5 to 30 psi). Certain compositions capable of allowing adhesion may not require to be spread during pressing step e), for example already cured adhesive coatings.

When vacuum is used for creating the application force, the typically applied force may be above 5 Newtons, preferably above 10 Newtons, more preferably above 15 Newtons. The typically applied force may be around 130 Newtons.

Air pressure may be applied using an inflatable membrane apparatus placed on the external surface of the carrier, as disclosed in international patent application WO 03/004255. A general description of a vacuum structure allowing transferring the coatings can be found in U.S. Pat. No. 4,242,162. The carrier of the process of the invention may be the inflatable membrane itself, in particular an inflatable membrane of an air accumulator apparatus.

In order to improve the conformation of a flexible carrier to the surface of the substrate onto which the coatings have to be transferred, especially if the transfer is implemented on the front surface of the substrate, one can use an additional means to increase the pressure on the carrier. Typically, one can use a pad, optionally deformable, which can conform to the general shape of the carrier and increase the pressure applied to the carrier.

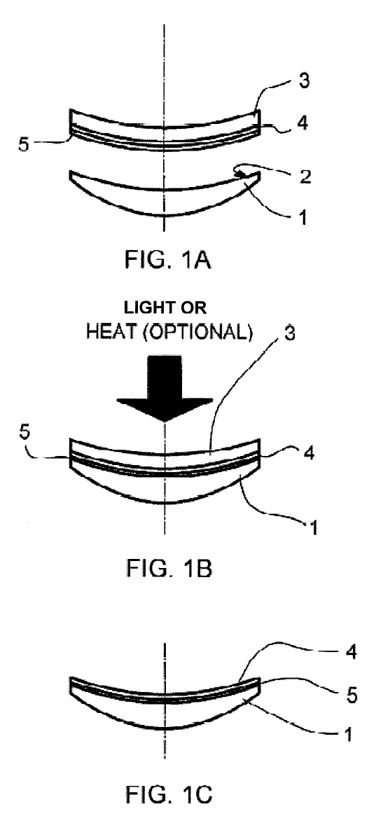

Referring now to the drawings, which only illustrate certain embodiments of the invention, and in particular to FIGS. 1A to 1C, a substrate 1 having a concave surface 2 is placed on a supporting element (not represented) with its concave (rear) surface 2 facing upwardly. A carrier 3, a main surface of which has been previously coated with a stack of coatings 4 according to the invention and a layer of a composition 5 capable of allowing adhesion of said surface of the substrate to the exposed surface of said coating stack, is placed onto a supporting element (not represented) with the layer of composition 5 facing downwardly.

Deposition of the coatings of the stack of coatings 4 and the adhesive composition layer 5 on the surface of the carrier 3 have been done through usual deposition processes employed in the optical field, such as vacuum deposition, spin coating, flow coating, dip coating etc. . . Of course, the deposition processes depend on the nature of the coating layers and of the adhesive composition layer deposited on the surface of the carrier 3.

Thereafter, the supporting elements are moved relatively to each other to bring into direct contact adhesive composition layer 5 and the surface of the substrate 2, which are then pressed together in such a manner that the exerted pressure shall be insufficient to impart any deformation to the substrate 1. Light or heat is optionally applied during pressing step e), depending on the nature of said composition 5. As shown in FIG. 1B, the assembly formed by the substrate 1, the adhesive composition layer 5, the coating stack 4, and the carrier 3 is placed into a device for heating in the particular case when heat has to be applied.

When step f) involves heating or heat-curing, such step is typically performed at a temperature ranging from 40 to 130° C., preferably from 60 to 120° C., more preferably from 80 to 110° C. The heating source can be, without limitation, an air oven with temperature from 70 to 110° C., a hot water bath from 70° C. to 100° C., or an IR heat source or a microwave source. Heating time can be from a few minutes to 30 minutes, for example heat is applied for 3 to 30 minutes.

After this optional heating or curing step, the applied pressure is released, the carrier 3 is withdrawn and the substrate 1 having the coating stack 4 adhering to its concave surface 2 through the layer of adhesive composition 5 is recovered as shown in FIG. 1C.

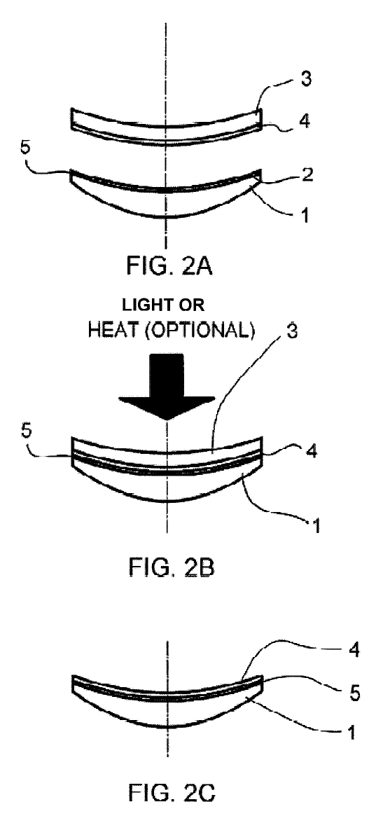

FIGS. 2A to 2C represent the main steps of a similar process as disclosed in connection with FIGS. 1A to 1C except that the adhesive composition layer 5 is formed on the concave (rear) surface 2 of the substrate 1.

The present transfer process can be applied in the ophthalmic lens industry to produce antistatic anti-reflection lenses, but also in the field of photographic films, electronics packaging and imaging materials.

Its advantages are numerous and include a low working temperature (generally ≦110° C.), the use of environmentally friendly solvents (water), flexibility (dip, spin or spray coating process are available), applicability to most of substrates with good adhesion and the production of optical articles having high transmittance, low haze, excellent antistatic properties and adhesion while maintaining excellent adhesion of the coatings (crosshatch test 0).

The present process provides optical articles having charge decay times ≦2 seconds, preferably ≦1 second, better ≦500 milliseconds, even better ≦200 milliseconds and best ≦150 milliseconds.

The final optical articles do preferably not absorb light in the visible range (or little), which means herein that when coated on one side according to the inventive process, the optical article has a luminous absorption in the visible range due to the AR and AS coatings of preferably 1% or less, more preferably less than 1%, and/or a relative light transmission factor in the visible spectrum, Tv, preferably higher than 90%, more preferably higher than 95%, and even more preferably higher than 96%. Preferably, both features are simultaneously satisfied and can be reached by carefully controlling thicknesses of the coatings.

As used herein, the Tv factor is such as defined in the standard NF EN 1836 and corresponds to the 380-780 nm wavelength range.

The final optical articles prepared according to the invention preferably have low haze characteristics. Haze is a measurement of the transmitted light scattered more than 2.5° from the axis of the incident light. The smaller the haze value, the lower the degree of cloudiness. The haze value of the present optical articles is preferably less than 0.8%, and more preferably less than 0.5%.

The invention also concerns a coated carrier for use in the process according to the invention, which is such as described above.

Said carrier has a main surface bearing a stack of coatings, said stack having an exposed surface and comprising an anti-reflection coating and optionally at least one functional coating, wherein:
α) said stack of coatings borne by the carrier further comprises, in addition to said anti-reflection coating, an organic antistatic coating comprising at least one conductive polymer; and/or
β) a layer of an adhesive composition is deposited on the exposed surface of the coating stack borne by the carrier, said adhesive composition being an organic antistatic coating composition comprising at least one conductive polymer, and/or at least one conductive polymer precursor, and at least one binder.

By “adhesive composition”, it is meant a composition capable of allowing adhesion of a geometrically defined surface of the substrate of an optical article to the exposed surface of the coating stack borne by the carrier. Said adhesive composition has been described previously and may be in a cured or curable state.

It is adhesive by itself or can be rendered adhesive. An example of such a composition which can be rendered adhesive is a dry latex layer which will be activated with at least one drop of an aqueous composition, such as previously described.

Ideally, said stack of coatings borne by the carrier comprises, starting from the carrier main surface, optionally a layer of protecting and releasing coating, an anti-fouling top coat, an anti-reflection coating, an abrasion- and/or scratch-resistant coating (hard coat), optionally an impact-resistant primer coating, and an antistatic coating comprising at least one conductive polymer, these coatings being deposited in the indicated order (reverse from the final order on the optical article).

Generally, the carrier has a concave surface and a convex surface and preferably bears the coating stack on its convex surface so as to be able to transfer said coating stack to the concave surface of the substrate of an optical article.

A layer of an adhesive composition may optionally be deposited on the exposed surface of the coating stack borne by the inventive carrier. It may be an antistatic adhesive composition such as disclosed in β), or a non antistatic adhesive composition being in a cured or curable state.

The inventive coated carrier may be stored and later used in the process of the invention.

The invention is further illustrated by the examples described below. These examples are meant to illustrate the invention and are not to be interpreted as limiting the scope of the invention.

### EXAMPLES

### 1. Testing Methods

The following test procedures were used to evaluate the optical articles prepared according to the present invention.

a) Charge Decay Time

In the present patent application, charge decay times of optical articles which have been beforehand subjected to a corona discharge at 900 volts were measured using JCI 155v5 Charge Decay Test Unit from John Chubb Instrumentation at 25.4° C. and 50% relative humidity.

The unit was set up with JCI 176 Charge Measuring Sample Support, JCI 191 Controlled Humidity Test Chamber, JCI 192 Dry Air Supply Unit and Calibration of voltage sensitivity and decay time measurement performance of JCI 155 to the methods specified in British Standard and Calibration voltage measurements and resistor and capacitor values traceable to National Standards.

b) Dry Adhesion Test

Dry adhesion of the transferred coatings was measured using the cross-hatch adhesion test according to ASTM D3359-93, by cutting through the coatings a series of 5 lines, spaced 1 mm apart with a razor, followed by a second series of 5 lines, spaced 1 mm apart, at right angles to the first series, forming a crosshatch pattern comprising 25 squares. After blowing off the crosshatch pattern with an air stream to remove any dust formed during scribing, clear cellophane tape (3M SCOTCH® n° 600) was then applied over the crosshatch pattern, pressed down firmly, and then rapidly pulled away from coating in a direction perpendicular to the coating surface. Application and removal of fresh tape was then repeated two additional times. Adhesion is rated as follows (0 is the best adhesion, 1-4 is in the middle, and 5 is the poorest adhesion):

TABLE 1

| Adhesion score | Squares removed | Area % left intact |
|---|---|---|
| 0 | 0 | 100 |
| 1 | <1 | >96 |
| 2 | 1 to 4 | 96–84 |
| 3 | >4 to 9 | 83–64 |
| 4 | >9 to 16 | 63–36 |
| 5 | >16 | <36 |

c) Haze Value and Tv

The haze value of the final optical article was measured by light transmission utilizing the Haze-Guard Plus haze meter from BYK-Gardner (a color difference meter) according to the method of ASTM D1003-00, which is incorporated herein in its entirety by reference. All references to “haze” values in this application are by this standard. The instrument was first calibrated according to the manufacturer's directions. Next, the sample was placed on the transmission light beam of the pre-calibrated meter and the haze value was recorded from three different specimen locations and averaged. Tv was measured using the same device.

### 2. Experimental Details

a) General Considerations

In examples 1 to 5, a carrier called “HMC-coated carrier” was employed. It is a spherical polycarbonate (PC) carrier with 6.0 curve bearing on its convex surface a coating stack including, starting from the carrier, a protecting and releasing coating, an anti-fouling top coat, an anti-reflection coating, an abrasion and/or scratch-resistant coating and an impact resistant primer coating.

The optical articles coated in the below described experiments were production ophthalmic lenses with 5.5 base (power: −2.00) sold under the name Airwear™ by Essilor, which comprise a polycarbonate (PC) substrate. The lenses had their concave sides coated according to the inventive process.

b) Antistatic Coating Compositions

Three antistatic coating compositions were used in the examples, providing antistatic coatings in the final coated lenses. Coating compositions A, B and C were respectively prepared by diluting the below indicated amounts of cross-linking polyurethane latex Witcobond® 240 (available from Baxenden Chemicals) and surfactants Silwet® L-77 and Silwet® L-7604 (both available from GE silicones) with deionized water. Then, the required amount of Baytron® P dispersion was slowly dropped in the agitated latex solution to avoid precipitation.

TABLE 2

| Component in | Coating composition | | |
|---|---|---|---|
| weight % | A | B | C |
| Baytron ® P | 25.000% | 25.000% | 12.500% |
| Witcobond ® 240 | 16.552% | 10.345% | 10.345% |
| (Latex) | | | |
| Silwet ® L-77 | 0.056% | 0.035% | 0.035% |
| (surfactant) | | | |
| Silwet ® L-7604 | 0.016% | 0.010% | 0.010% |
| (surfactant) | | | |
| Deionized H₂O | 58.376% | 64.610% | 77.110% |

c) Preparation of the HMC-Coated Carrier

c.1) Deposition of a Protecting and Releasing Coating

The composition of the protecting and releasing coating composition was as follows:

TABLE 3

| Component | Parts by weight |
|---|---|
| PETA LQ (acrylic ester of | 5.00 |
| pentaerythritol) | |
| Dowanol PnP | 5.00 |
| Dowanol PM | 5.00 |
| n-propanol | 5.00 |
| Radcure 1360 (Silicon hexa- | 0.10 |
| acrylate) | |
| Coat-O-Sil 3503 (reactive flow | 0.06 |
| additive) | |
| Photoinitiator | 0.20 |

The PC carrier was cleaned using soapy water and dried with compressed air. The carrier convex surface was then coated with the above protecting coating composition via spin coating with application speed of 600 rpm for 3 seconds and dry speed of 1200 rpm for 6 seconds. The coating was cured using Fusion System H+ bulb at a rate of 1.524 m/minute (5 feet per minute).

This protecting and releasing coating will not be transferred and will stay on the carrier once the coating stack has been transferred.

c.2) Deposition of an Anti-Fouling Top Coat and Anti-Reflection (AR) Coating

The resulting PC carrier was vacuum coated as follows. The carrier having the protective coating already applied on its convex surface was loaded into a standard box coater and the chamber was pumped to a high vacuum level. A KP 801M® anti-fouling coating from Shin-Etsu Chemical was deposited onto the surface of the carrier using a thermal evaporation technique, to a thickness in the range of 2-15 nm.

The dielectric multilayer AR coating, consisting of an alternated stack of high and low refractive index layers was then vacuum-deposited, in reverse of the normal order. The layers were deposited in the indicated order, from the carrier surface: SiO₂ 103-162 nm, ZrO₂ 124-190 nm, SiO₂ 19-37 nm, ZrO₂ 37-74 nm (optical thicknesses).

At the completion of the deposition of the four-layer anti-reflection stack, a SiO₂ sub-layer was deposited. This layer is intended to promote adhesion between the oxide anti-reflection stack and the hard-coating which will be subsequently deposited onto the coated carrier.

c.3) Deposition of an Abrasion and Scratch Resistant Coating and a Latex Primer Coating

The composition of the hard coating composition was as follows:

TABLE 4

| Component | Parts by weight |
|---|---|
| GLYMO | 21.42 |
| 0.1N HCl | 4.89 |
| Colloidal silica | 30.50 |
| Methanol | 29.90 |
| Diacetone alcohol | 3.24 |
| Aluminum acetylacetonate | 0.45 |
| Coupling agent | 9.00 |
| Surfactant FC-430 (3M | 0.60 |
| company) | |

The coated PC carrier was spin coated with the above composition at 600 rpm/1200 rpm, and pre-cured for 10 minutes at 80° C.

The composition of the impact resistant primer coating composition was as follows:

TABLE 5

| Component | Parts by weight |
|---|---|
| Polyurethane latex | 35.0 |
| Witcobond ® 234 | |
| Deionized water | 50.0 |
| 2-butoxy ethanol | 15.0 |
| Coupling agent | 5.0 |

The coated PC carrier was spin coated at the same speed with the impact resistant primer coating composition set forth in table 5 and post-cured for 1 hour at 80° C., providing a dry latex layer having a thickness of about 1.8 to 2 microns.

In both coatings, the coupling agent was a pre-condensed solution of:

TABLE 6

| Component | Parts by weight |
|---|---|
| GLYMO | 10.0 |
| Acryloxypropyl trimethoxysilane | 10.0 |
| 0.1N HCl | 0.5 |
| Aluminum acetylacetonate | 0.5 |
| Diacetone alcohol | 1.0 |

d) Transfer General Procedure (in Connection with FIGS. 1 and 2)

The above described HMC-coated carrier was first corona-treated and spin-coated with a Baytron® P-based antistatic coating composition (A, B or C), which was oven dried at 60° C. for 10 minutes (alternatively, air drying for 30 minutes could be performed). Then, a few drops of the same Baytron® P-based antistatic coating adhesive composition (examples 1-3, third or fourth preferred embodiment), water (example 4, fourth preferred embodiment), or adhesive curable coating composition (cross-linking latex Witcobond® 234 used as a HMA glue which becomes tacky when heated above 60° C., example 5, first preferred embodiment) were deposited onto a concave Airwear™ lens surface. Then, the coated carrier was set on the Airwear™ lens into a membrane apparatus as described in WO03/004255, and an air pressure of 20-25 psi was applied. The membrane apparatus with the assembly of coated carrier and lens were kept for about 60 minutes in an oven at 110° C. under the same pressure, taken out from the oven and cooled down to room temperature.

The pressure was released; the carrier was removed, providing a lens having the coating stack transferred to its surface.

e) Test Results

The performance test data of the resulting coated lenses are collected in Table 7.

TABLE 7

| | | | | | Charge |
|---|---|---|---|---|---|
| | Antistatic | | Haze | Dry | decay |
| | coating | | value | adhesion | time |
| Example | composition | Tv (%) | (%) | test | (ms) |
| 1 | A | 95.7 | 0.38 | 0 | 76 |
| 2 | B | 95.6 | 0.26 | 0 | 92.8 |
| 3 | C | 95.8 | 0.17 | 0 | 133 |
| 4 | B | 95.7 | 0.23 | 0 | 96.2 |
| 5 | B | 95.5 | 0.28 | 0 | 102 |
| Control* | None | 92.0 | 0.10 | 0 | 30,400 |

*Bare Airwear ™ lens.

The resulting lenses made through the inventive process presented high transmittance, low haze, excellent antistatic properties and AR performances. The transferred coating stack had very good adhesion on the lens surface with a dry adhesion score of 0. There was no AR cracking during the transfer.

While the present methods may be adaptable to various modifications and alternative forms, specific embodiments have been shown by way of example. The different aspects of the disclosed methods, articles and compositions may be utilized in various combinations and/or independently. However, it should be understood that the present methods, articles and compositions are not to be unduly limited to only those particular illustrative embodiments set forth herein, but rather may include numerous other combinations and modifications. Those of skill in the art will understand that the present methods, articles and compositions cover all modifications, equivalents, and alternatives falling within the scope of the claims.

1.-29. (canceled)

30. A process for transferring a stack of coatings borne by a removable carrier onto at least one geometrically defined surface of the substrate of an optical article, comprising:
(a) obtaining a carrier having a main surface bearing a stack of coatings, said stack having an exposed surface and comprising at least the following coatings:
an anti-reflection coating, and
at least one functional coating;
(b) obtaining an optical article comprising a substrate having at least one geometrically defined surface;
(c) depositing either onto the exposed surface of the coating stack borne by the carrier or the at least one geometrically defined surface of the substrate, a layer of a composition capable of allowing adhesion of said at least one geometrically defined surface of the substrate to the exposed surface of said coating stack;
(d) moving the carrier and the optical article relative to each other to bring the deposited layer of composition capable of allowing adhesion into contact with either said at least one geometrically defined surface of the substrate or the exposed surface of said coating stack;
(e) pressing together the at least one geometrically defined surface of the substrate and the exposed surface of said coating stack, said layer of composition capable of allowing adhesion lying there between;
(f) heating or curing the layer of composition capable of allowing adhesion during pressing step (e);
(g) stopping pressing step (e); and
(h) withdrawing the removable carrier to recover an optical article having a substrate coated with said coating stack adhering to said at least one geometrically defined surface through the layer of composition allowing adhesion, wherein:
said stack of coatings borne by the removable carrier further comprises, in addition to said anti-reflection coating, an organic antistatic coating comprising at least one conductive polymer; and/or
said composition capable of allowing adhesion is an organic antistatic coating composition comprising at least one conductive polymer, and/or at least one conductive polymer precursor, and at least one binder.

31. The process of claim 30, wherein said stack of coatings which is borne by the carrier comprises at least one functional coating selected from an anti-fouling top coat, an anti-abrasion- and/or scratch-resistant coating, an impact-resistant coating, a polarized coating, a photochromic coating, a dyed coating, a printed layer, a microstructured layer.

32. The process of claim 30, wherein the outermost coating of the coating stack to be transferred is said antistatic coating comprising at least one conductive polymer.

33. The process of claim 30, wherein the antistatic coating is deposited onto an impact-resistant coating or an abrasion- and/or scratch-resistant coating borne by the carrier.

34. The process of claim 30, wherein the conductive polymer is chosen from polyanilines, polypyrroles, polythiophenes, polyethylene-imines, polyselenophenes, compounds based on allylamine such as poly(allylamine), copolymers thereof, derivatives of those polymers and mixtures thereof.

35. The process of claim 30, wherein the conductive polymer is chosen from polypyrroles polystyrene sulfonate, polythiophenes polystyrene sulfonate and mixtures thereof.

36. The process of claim 30, wherein the antistatic coating is formed by deposition of a liquid antistatic coating composition comprising at least one conductive polymer.

37. The process of claim 36, wherein the antistatic coating composition comprises at least one binder.

38. The process of claim 37, wherein the binder is an epoxy alkoxysilane.

39. The process of claim 30, wherein the antistatic coating composition comprises a dispersion or solution of at least one conductive polymer in an aqueous or organic solvent, or a mixture of these solvents.

40. The process of claim 30, wherein the binder is a polymer material soluble or dispersible in water or in an aqueous composition chosen from binders based on functionalized silane, siloxane or silicate, or homopolymers or copolymers of the following monomers: styrene, vinylidene chloride, vinyl chloride, alkyl acrylates, alkyl methacrylates, (meth)acrylamides, polyester homopolymers or copolymers, poly(urethane-acrylate), poly(ester-urethane), polyether, vinyl polyacetate, polyepoxyde, polybutadiene, polyacrylonitrile, polyamide, melamine, polyurethane, polyvinylic alcohol, copolymers thereof, and mixtures thereof.

41. The process of claim 30, wherein the binder is used under a latex form or a mixture of latexes.

42. The process of claim 41, wherein the latex is chosen from polyurethane latexes, poly(meth)acrylic latexes, polyester latexes and mixtures thereof.

43. The process of claim 41, wherein the latex is a polyurethane latex comprising polyester moieties.

44. The process of claim 30, wherein the ratio of total weight of solid binder components/total weight of the antistatic coating composition ranges from 2 to 7%.

45. The process of claim 30, wherein the thickness of the antistatic coating borne by the carrier ranges from 5 to 750 nm.

46. The process of claim 30, wherein the composition capable of allowing adhesion is a curable coating composition which is heat-curable and/or light-curable.

47. The process of claim 30, wherein the composition capable of allowing adhesion is an adhesive curable coating composition selected from the group consisting of pressure-sensitive adhesives and hot-melt adhesives.

48. The process of claim 30, wherein step c) comprises:
c1) forming, either onto the exposed surface of the coating stack borne by the carrier or the at least one geometrically defined surface of the substrate, a layer of a dry latex as a layer of a composition capable of allowing adhesion;
c2) depositing at least one drop of an aqueous composition either onto said at least one geometrically defined surface of the substrate, the exposed surface of said coating stack or onto the surface of the dry latex layer; and wherein steps e) and f) respectively comprise:
e) pressing together the at least one geometrically defined surface of the substrate and the exposed surface of said coating stack, so as to spread the aqueous composition and form a thin pellicle of the aqueous composition between the dry latex layer and either the substrate or the exposed surface of the coating stack borne by the carrier; and
f) heating the thin pellicle of aqueous composition and the dry latex layer during pressing step (e).

49. The process of claim 48, wherein the dry latex layer further comprises at least one conductive polymer.

50. The process of claim 30, wherein the composition capable of allowing adhesion is a curable organic antistatic coating composition comprising at least one conductive polymer, and/or at least one conductive polymer precursor, and at least one binder.

51. The process of claim 30, wherein the substrate is made of mineral glass or organic glass.

52. The process of claim 30, wherein the optical article is an ophthalmic lens.

53. The process of claim 30, wherein the exposed surface of the coating stack borne by the carrier or the at least one geometrically defined surface of the substrate is subjected before step c) to a pre-treatment intended to promote adhesion of said layer of composition capable of allowing adhesion, said pre-treatment being chosen from a high-frequency discharge plasma method, a glow discharge plasma method, a corona discharge treatment, a bombardment with energetic species such as an electron beam method or an ion beam method, an acid or base pre-treatment or a solvent pre-treatment.

54. A carrier having a main surface bearing a stack of coatings, said stack having an exposed surface and comprising an anti-reflection coating, wherein:
said stack of coatings borne by the carrier further comprises, in addition to said anti-reflection coating, an organic antistatic coating comprising at least one conductive polymer; and/or
a layer of an adhesive composition is deposited on the exposed surface of the coating stack borne by the carrier, said adhesive composition being an organic antistatic coating composition comprising at least one conductive polymer, and/or at least one conductive polymer precursor, and at least one binder.

55. The carrier of claim 54, wherein the stack further comprises at least one functional coating.

56. The carrier of claim 54, wherein the carrier is made of polycarbonate.

57. The carrier of claim 54, wherein a layer of an adhesive composition is deposited on the exposed surface of the coating stack borne by the carrier.

58. The carrier of claim 54, wherein said stack of coatings borne by the carrier comprises, starting from the carrier main surface, an anti-fouling top coat, an anti-reflection coating, an abrasion- and/or scratch-resistant coating, and an antistatic coating comprising at least one conductive polymer.

59. The carrier of claim 58, wherein the stack further comprises a layer of protecting and releasing coating and/or an impact-resistant primer coating.

60. The carrier of claim 54, wherein the antistatic coating comprises at least one cured binder.
